(19) United States
(12) Patent Application Publication
(10) Pub. No.: US 2026/0154478 A1
(43) Pub. Date: Jun. 4, 2026

(54) METHOD FOR POWER PRODUCTION SIMULATION AND CONFIGURATION OPTIMIZATION BASED ON NUMERICAL SIMULATION, DEVICE, AND PRODUCT

(71) Applicants: North China Electric Power University, Beijing (CN); NARI Technology Development Co.,Ltd., Nanjing City (CN)

(72) Inventors: Nian LIU, Beijing (CN); Kai JIANG, Beijing (CN); Jie HUANG, Nanjing City (CN); Zhen WANG, Nanjing City (CN); Lei WANG, Beijing (CN)

(21) Appl. No.: 19/401,041

(22) Filed: Nov. 25, 2025

(30) Foreign Application Priority Data
Dec. 4, 2024 (CN) 202411770858.6

(51) Int. Cl. G06F 30/27; G06Q 40/06

(52) U.S. Cl. CPC G06F 30/27; G06Q 40/0631

(57) ABSTRACT

Provided are a method for power production simulation and configuration optimization based on numerical simulation, a device, and a product. The method includes: constructing an investment cost evolution model according to relevant historical data and future planning data; constructing a capacity evolution sequence generation model according to investment-cost-per-unit-capacity evolution prediction data output by the investment cost evolution model; generating multiple operating scenarios of a power system according to the relevant historical data; constructing a time-series production simulation model of the power system containing hydrogen long-duration energy storage according to a given capacity evolution sequence output by the capacity evolution sequence generation model and the multiple operating scenarios; constructing a data-model hybrid-driven model; constructing a low-carbon evolution path simulation model of the power system; and obtaining a power system low-carbon evolution path considering hydrogen long-duration energy storage according to the low-carbon evolution path simulation model of the power system.

### CROSS REFERENCE TO RELATED APPLICATION

This patent application claims the benefit and priority of Chinese Patent Application No. 202411770858.6, filed with the China National Intellectual Property Administration on Dec. 4, 2024, the disclosure of which is incorporated by reference herein in its entirety as part of the present application.

### TECHNICAL FIELD

The present disclosure relates to the technical field of new energy, and in particular, to a method for simulating a low-carbon evolution path of a power system, a device, a medium, and a product.

### BACKGROUND

Under the guidance of the dual carbon goals, the current power system is developing towards a clean and low-carbon direction. The power system should minimize the investment in and construction of coal-fired units, replacing the output of traditional power source units with that of clean energy units. However, this may exacerbate the dilemma of unstable power supply. Meanwhile, large-scale grid integration of high-proportion new energy will bring more severe new energy consumption problems. To improve the utilization rate of new energy, the use of long-term energy storage represented by hydrogen energy systems shows excellent potential and plays an important role in solving the dilemma of new energy consumption and accelerating the low-carbon transformation of the power system. Therefore, in the process of the power system evolving into an integrated system comprising electricity, hydrogen, and carbon, how to balance the system economy, low-carbon performance, and cleanliness of the system, and realize the simulation of a power system evolution path driven by multiple factors, is the key issue of concern in the present disclosure.

### SUMMARY

An objective of the present disclosure is to provide a method for simulating a low-carbon evolution path of a power system, a device, a medium, and a product, which can improve the utilization rate of new energy while balancing the economy, low-carbon performance, and cleanliness in the process of the power system developing into an integrated system comprising electricity, hydrogen, and carbon.

To achieve the above objective, the present disclosure provides the following technical solutions.

According to a first aspect, the present disclosure provides a method for simulating a low-carbon evolution path of a power system, including:
acquiring relevant historical data on energy costs in a target region, future planning data of the target region, a maximum allowable construction scale for equipment corresponding to various types of energy sources in the target region, a construction scale of currently constructed equipment in the target region, and planned retirement time of the currently constructed equipment in the target region, where the future planning data includes future planned installed capacities and future planned research and development investments for the various types of energy sources; the relevant historical data includes installed capacities, research and development investments, and investment costs per unit capacity of the various types of energy sources over years;
constructing an investment cost evolution model considering uncertainty of technological innovation breakthrough rate according to the relevant historical data and the future planning data;
constructing a capacity evolution sequence generation model according to investment-cost-per-unit-capacity evolution prediction data output by the investment cost evolution model, the maximum allowable construction scale for equipment corresponding to various types of energy sources, the construction scale of currently constructed equipment, and the planned retirement time, where the capacity evolution sequence generation model adopts an objective function of minimizing a sum of an investment cost and a maintenance cost and takes equipment capacity connection constraints and capacity limit constraints as constraint conditions;
generating multiple operating scenarios of a power system by using a k-means clustering algorithm according to the relevant historical data;
constructing a time-series production simulation model of the power system containing hydrogen long-duration energy storage according to a given capacity evolution sequence output by the capacity evolution sequence generation model and the multiple operating scenarios of the power system, where the time-series production simulation model of the power system takes carbon emission limit constraints and clean energy power generation share constraints as core constraints and adopts an objective function of minimizing a sum of an operating cost and a carbon trading cost;
constructing a data-model hybrid-driven model capable of measuring system cleanliness and low-carbon performance by using convolutional neural network-bidirectional gated recurrent unit-attention mechanism (CNN-BiGRU-AM), based on the capacity evolution sequence generation model and the time-series production simulation model of the power system containing hydrogen long-duration energy storage, where the data-model hybrid-driven model takes the capacity evolution sequence output by the capacity evolution sequence generation model as input and takes a corresponding marginal cost of electricity share and a corresponding marginal cost of carbon allowances as output;
constructing a low-carbon evolution path simulation model of the power system according to the marginal cost of electricity share, the marginal cost of carbon allowances, a minimized sum of the investment cost and the maintenance cost, and a minimized sum of the operating cost and the carbon trading cost, where the low-carbon evolution path simulation model of the power system considers hydrogen long-duration energy storage and involves economic cost driving factors, clean energy power generation share driving factors, and carbon emission limit driving factors; and
constructing a two-layer solution framework according to the low-carbon evolution path simulation model of the power system, where the two-layer solution framework includes a capacity layer and an operation layer and has an objective of minimizing a comprehensive benefit cost, the capacity layer adopts a Proportional-Integral-Derivative (PID) search algorithm and the operation layer adopts an improved differential evolution algorithm to obtain a low-carbon evolution path of the power system considering hydrogen long-duration energy storage.

Optionally, according to the relevant historical data and the future planning data, the investment cost evolution model considering the uncertainty of technological innovation breakthrough rate is constructed based on a two-factor learning curve model.

Optionally, the investment cost evolution model is:

$${α}_{y} = {α}_{0} {A}_{y} {B}_{y} ;$$

$${A}_{y} = {( \frac{{N}_{y}}{{N}_{0}} )}^{- a} ;$$

$${B}_{y} = {u}_{y} {( \frac{{C}_{y}}{{C}_{0}} )}^{- b} + ( 1 - {u}_{y} ) {B}_{y - 1} ;$$

where α_{y} is an investment cost per unit capacity in a y-th year; α₀ is an initial investment cost per unit capacity; A_{y} is a reduction level of the investment cost per unit capacity caused by an increase in an installed capacity scale in the y-th year; B_{y} is a reduction level of the investment cost per unit capacity caused by an increase in a research and development investment in the y-th year; N_{y} is a cumulative installed capacity scale in the y-th year; N₀ is an initial installed capacity scale; a is a learning rate index of the cumulative installed capacity scale; u_{y} is a binary variable that is set to 1 after a breakthrough is made in technological innovation and set to 0 if no breakthrough is made in technological innovation; C_{y} is a cumulative research and development investment in the y-th year; C₀ is an initial research and development investment; b is a learning rate index of the cumulative research and development investment; and B_{y-1} is a reduction level of the investment cost per unit capacity caused by an increase in the research and development investment in a (y−1)-th year.

Optionally, the objective function of the capacity evolution sequence generation model is:

$$min {F}_{1} = min ( {F}^{inv} + {F}^{main} )$$

$${F}^{inv} = {\sum }_{{Ω}^{kn}} {\sum }_{{Ω}^{y}} ( {c}_{kn , y}^{inv , p} {P}_{kn , y} + {c}_{kn , y}^{inv , e} {E}_{kn , y} ) - {F}^{sa}$$

$${F}^{sa} = {\sum }_{{Ω}^{k}} {ρ}_{k} ( {c}_{k , Y}^{inv , p} {P}_{k , Y} + {c}_{k , Y}^{inv , e} {E}_{k , Y} ) \frac{{H}_{k , Y}}{{T}_{k}}$$

$${H}_{k , Y} = \{ \begin{matrix}0 , & {Y}_{0} \leq ( Y - {T}_{k} + 1 ) \\ {T}_{k} - ( Y - {Y}_{0} + 1 ) , & {Y}_{0} > ( Y - {T}_{k} + 1 )\end{matrix}$$

$${F}^{main} = {\sum }_{{Ω}^{k}} {\sum }_{{Ω}^{y}} ( {c}_{k , y}^{main , p} {P}_{k , y} + {c}_{k , y}^{main , e} {E}_{k , y} )$$

where F₁ is a cost of the capacity evolution sequence generation model; F^{inv} is the investment cost; F^{main} is the maintenance cost; Ω^{kn} is a set of newly added devices; Ω^{y} is a set of planning years;

$${c}_{kn , y}^{inv , p}$$

is investment costs per unit capacity of various types of energy devices; P_{kn,y} is an installed capacity of newly added devices in a y-th year;

$${c}_{kn , y}^{inv , e}$$

is investment costs per unit energy of the various types of energy devices; E_{kn,y} is energy of the newly added devices in the y-th year; F^{sa} is a residual value of non-retired devices within a planning period; Ω^{k} is a set of online energy devices; ρₖ is a residual value recovery coefficient;

$${c}_{k , Y}^{inv , p}$$

is an investment cost per unit capacity in a final year of the planning period; P_{k,Y} is an installed capacity in the final year of the planning period;

$${c}_{k , Y}^{inv , e}$$

is an investment cost per unit energy in the final year of the planning period; E_{k,Y} is energy in the final layer of the planning period; H_{k,Y} is remaining lifespans of the various types of energy devices at the end of the planning period; Tₖ is service life of various types of energy devices; Y₀ is a time point when an energy device begins to be used;

$${c}_{k , y}^{main , p}$$

is maintenance costs per unit capacity of various types of energy devices;

$${c}_{k , y}^{main , e}$$

is maintenance costs per unit energy of various types of energy devices; and Y is the final year of the planning period.

Optionally, the objective function of the time-series production simulation model of the power system containing hydrogen long-duration energy storage is:

$$min {F}_{2} = min ( {F}^{o m} + {F}^{c o} ) ;$$

$${F}^{o m} = {\sum }_{{Ω}^{k}} {\sum }_{{Ω}^{y}} {\sum }_{{Ω}^{s}} {\sum }_{{Ω}^{t}} ( {c}_{y}^{c o a l} {q}_{k , y , s , t}^{coal} + {c}_{y}^{gas} {q}_{k , y , s , t}^{gas} + {c}_{y}^{h y} {q}_{k , y , s , t}^{hy} ) Δ t + {C}_{k , y , s , t}^{U} + {C}_{k , y , s , t}^{D}$$

$${F}^{c o} = {\sum }_{{Ω}^{y}} {c}_{y}^{c o} \cdot {CO}_{y}$$

where F₂ is a cost of the time-series production simulation model; F^{om} is the operating cost; F^{co} is the carbon trading cost; Ω^{k} is a set of online energy devices; Ω^{y} is a set of planning years; Ω^{s} is a set of operating scenarios; Ω^{t} is a set of daily operating times;

$${c}_{y}^{c o a l}$$

is a cost per unit of coal consumption;

$${q}_{k , y , s , t}^{c o a l}$$

is coal consumption;

$${c}_{y}^{gas}$$

is a cost per unit of natural gas consumption;

$${q}_{k , y , s , t}^{gas}$$

is natural gas consumption;

$${c}_{y}^{hy}$$

is a cost per unit of hydrogen consumption;

$${q}_{k , y , s , t}^{hy}$$

is hydrogen consumption; Δt is a time interval;

$${C}_{k , y , s , t}^{U}$$

is a startup cost of thermal power units (including coal-fired and gas-fired);

$${C}_{k , y , s , t}^{D}$$

is a shutdown cost;

$${c}_{y}^{c o}$$

is a carbon trading price in a y-th year; CO_{y} is a total carbon trading volume in the y-th year.

Optionally, the constructing the data-model hybrid-driven model capable of measuring system cleanliness and low-carbon performance specifically by using the CNN-BiGRU-AM, based on the capacity evolution sequence generation model and the time-series production simulation model of the power system containing hydrogen long-duration energy storage includes:
applying a random function to generate a random capacity evolution sequence based on the capacity evolution sequence generation model;
inputting the random capacity evolution sequence into the time-series production simulation model of the power system containing hydrogen long-duration energy storage to obtain the minimized sum of the operating cost and the carbon trading cost;
calculating the corresponding marginal cost of electricity share and marginal cost of carbon allowances by adjusting clean energy power generation share or a carbon emission limit, with reference to the minimized sum of the operating cost and the carbon trading cost; and
with the random capacity evolution sequence as input and the corresponding marginal cost of electricity share and the corresponding marginal cost of carbon allowances as output, training the CNN-BiGRU-AM to obtain the data-model hybrid-driven model capable of measuring system cleanliness and low-carbon performance.

Optionally, the low-carbon evolution path simulation model of the power system considering hydrogen long-duration energy storage is:

$$V = {ω}^{F} {V}^{F} + {ω}^{n e w} {V}^{n e w} + {ω}^{c o} {V}^{c o} ;$$

where V is a comprehensive benefit cost value; ω^{F} is a weight coefficient under an economic cost driver; V^{F} is a benefit cost value under the economic cost driver; ω^{new} is a weight coefficient under a clean energy power generation share driver; V^{new} is a benefit cost value under the clean energy power generation share driver; ω^{co} is a weight coefficient under a carbon emission limit driver; and V^{co} is a benefit cost value under the carbon emission limit driver.

According to a second aspect, the present disclosure provides a computer device, including a memory, a processor, and a computer program stored in the memory and executable on the processor, where the processor executes the computer program to perform the steps of the method for simulating a low-carbon evolution path of a power system described above.

According to a third aspect, the present disclosure provides a computer-readable storage medium that stores a computer program, where the computer program, when executed by a processor, implements the method for simulating a low-carbon evolution path of a power system described above.

According to a fourth aspect, the present disclosure provides a computer program product, including a computer program, where the computer program, when executed by a processor, implements the method for simulating a low-carbon evolution path of a power system described above.

According to specific embodiments provided in the present disclosure, the present disclosure achieves the following technical effects:

The present disclosure provides a method for simulating a low-carbon evolution path of a power system, a device, a medium, and a product. Firstly, relevant historical data on energy costs in a target region and future development levels are acquired; an investment cost evolution model considering the uncertainty of technological innovation breakthrough rate is constructed; based on the relevant historical data of energy costs, a differential evolution algorithm is used to solve model parameters, then investment costs per unit capacity of energy sources are predicted, and a maximum allowable construction scale for various types of equipment in the target region as well as a construction scale of currently constructed equipment and planned retirement time of the currently constructed equipment in the target region are acquired, thereby constructing a capacity evolution sequence generation model in combination with cost prediction data, with an objective function of minimizing a sum of an investment cost and a maintenance cost, and with equipment capacity connection constraints and capacity limit constraints as constraint conditions. Then, historical data of actual operation of electrical load, wind power output, and photovoltaic output in the target region is acquired, and basic operating scenarios are generated using a k-means clustering algorithm; with an objective of minimizing a sum of an operating cost and a carbon trading cost, a time-series production simulation model of the power system containing hydrogen long-duration energy storage is constructed, where carbon emission limit constraints and clean energy power generation share constraints are taken as core constraints. An objective function of this model is to minimize the sum of the operating cost and the carbon trading cost, and constraint conditions mainly include electric energy module constraints, hydrogen energy module constraints, carbon module constraints, and driving factor constraints. Finally, based on the capacity evolution sequence generation model and the time-series production simulation model of the power system containing hydrogen long-duration energy storage, a data-model hybrid-driven model capable of measuring system cleanliness and low-carbon performance is constructed; further, by integrating economic cost driving factors, clean energy power generation share driving factors, and carbon emission limit driving factors, a low-carbon evolution path simulation model of the power system considering hydrogen long-duration energy storage and a solution framework are constructed. For the established model, based on a hierarchical optimization idea, a double-layer solution framework is constructed, aiming at minimizing a comprehensive benefit cost, where a capacity layer adopts a PID search algorithm and an operation layer adopts an improved differential evolution algorithm, and evolution results are output, thereby forming a low-carbon evolution path of the power system considering hydrogen long-duration energy storage. Simulation results of the low-carbon evolution path of the power system considering hydrogen long-duration energy storage can improve the utilization rate of new energy while balancing the system economy, low-carbon performance, and cleanliness in the process of the power system evolving into a system integrating multiple factors of electricity, hydrogen, and carbon.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic framework diagram of a method for simulating a low-carbon evolution path of a power system considering hydrogen long-duration energy storage according to an embodiment of the present disclosure;

FIG. 2 is a schematic flowchart of a specific implementation of a method for simulating a low-carbon evolution path of a power system according to an embodiment of the present disclosure;

FIG. 3 is a schematic flowchart of a method for simulating a low-carbon evolution path of a power system according to an embodiment of the present disclosure; and

FIG. 4 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

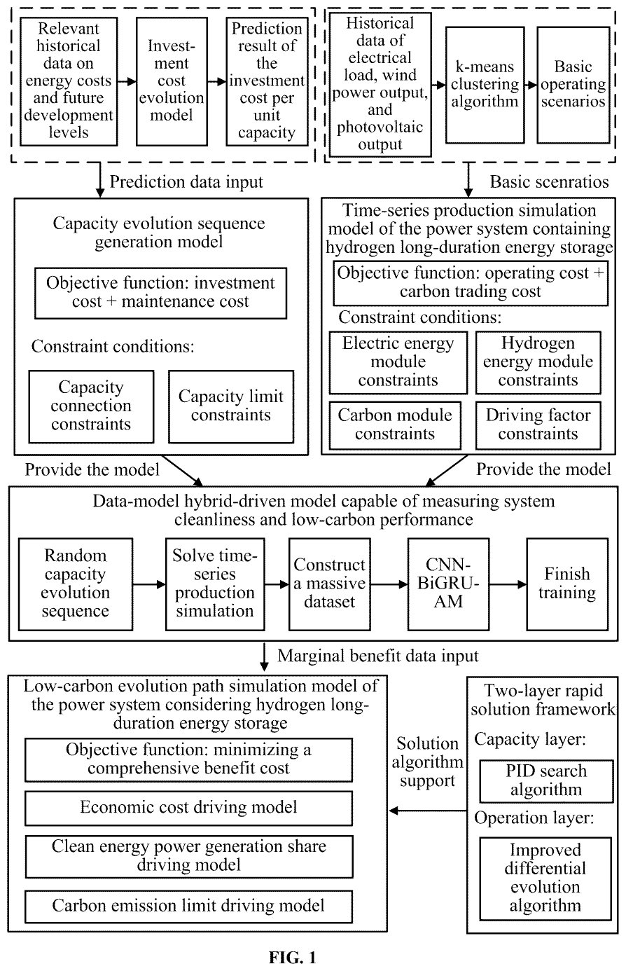

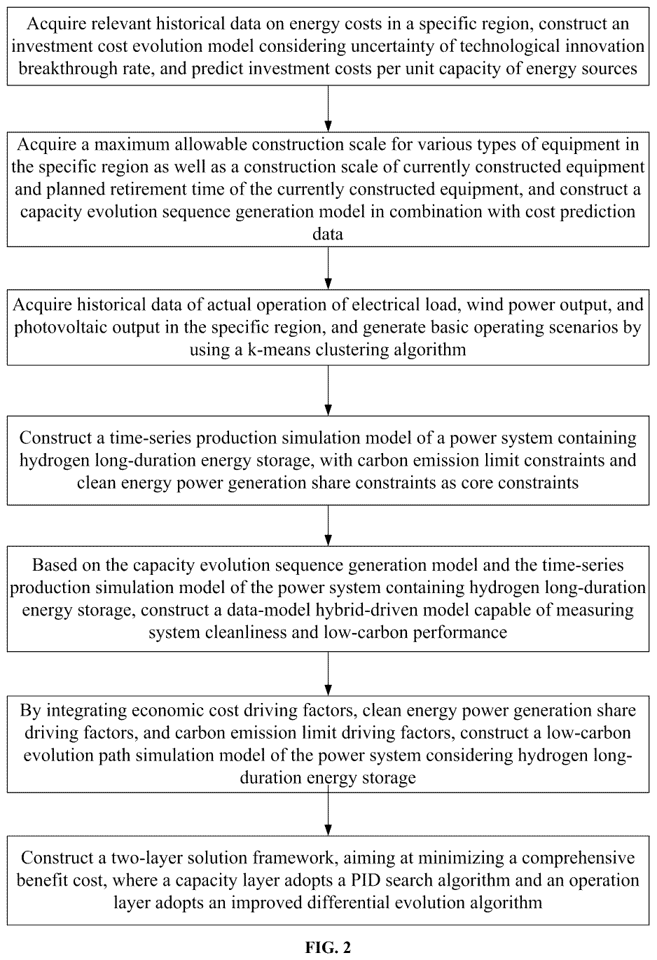

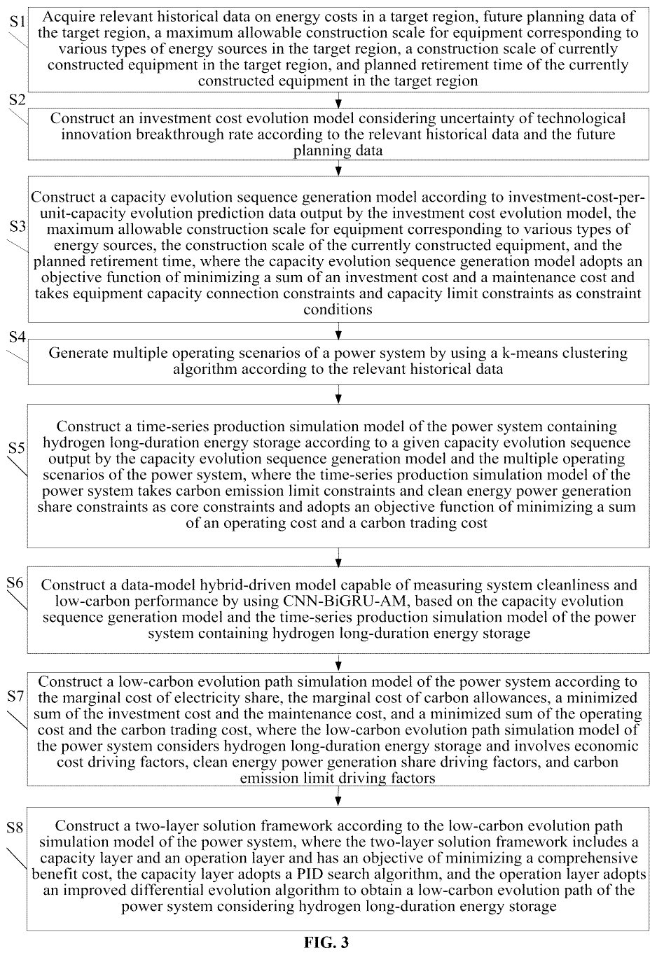

As shown in FIG. 1 to FIG. 3, an embodiment of the present disclosure provides a method for simulating a low-carbon evolution path of a power system, including the following steps:

Step S1: Acquire relevant historical data on energy costs in a target region, future planning data of the target region, a maximum allowable construction scale for equipment corresponding to various types of energy sources in the target region, a construction scale of currently constructed equipment in the target region, and planned retirement time of the currently constructed equipment in the target region, where the future planning data includes future planned installed capacities and future planned research and development investments for various types of energy sources; the relevant historical data includes installed capacities, research and development investments, and investment costs per unit capacity of the various types of energy sources over years.

Specifically, according to the relevant historical data and the future planning data, the investment cost evolution model considering uncertainty of technological innovation breakthrough rate is constructed based on a two-factor learning curve model.

Step S2: Construct an investment cost evolution model considering uncertainty of technological innovation breakthrough rate according to the relevant historical data and the future planning data.

In practical applications, first, relevant historical data on energy costs in a specific region is acquired, including the installed capacities, research and development investments, and investment costs per unit capacity of the various types of energy sources over years; future development situations of installed capacity scale and future research and development investment intensities for various types of energy sources in the specific region are acquired.

Secondly, the decline in the investment costs per unit capacity of various types of energy sources partially owes to experience accumulation, which is regarded as the result of the growth of energy installed capacity scale, and also partially owes to research and development accumulation, which is regarded as the result of the growth of research and development investment in the energy industry. According to the above historical data, the investment cost evolution model considering the uncertainty of technological innovation breakthrough rate is constructed based on a two-factor learning curve model. The investment cost evolution model is specifically as follows:

$${α}_{y} = {α}_{0} {A}_{y} {B}_{y} \qquad ( 1 )$$

$${A}_{y} = {( \frac{{N}_{y}}{{N}_{0}} )}^{- a} \qquad ( 2 )$$

$${B}_{y} = {{u}_{y} ( \frac{{c}_{y}}{{c}_{0}} )}^{- b} + ( 1 - {u}_{y} ) {B}_{y - 1} \qquad ( 3 )$$

In formula (1): A_{y} is a reduction level of the investment cost per unit capacity caused by an increase in the installed capacity scale in a y-th year; B_{y} is a reduction level of the investment cost per unit capacity caused by an increase in the research and development investment in the y-th year; α₀ is an initial investment cost per unit capacity; and α_{y} is an investment cost per unit capacity in the y-th year. In formula (2): N_{y} is a cumulative installed capacity scale in the y-th year, N₀ is an initial installed capacity scale, and a is a learning rate index of the cumulative installed capacity scale. In formula (3): C_{y} is a cumulative research and development investment in the y-th year; C₀ is an initial research and development investment; b is a learning rate index of the cumulative research and development investment; and u_{y} is a binary variable, which is set to 1 after a breakthrough is made in technological innovation and set to 0 if no breakthrough is made in technological innovation.

When the research and development investment accumulates to a particular extent and the technological breakthrough rate reaches the target, the benefit of the research and development investment B_{y} in reducing the cost per unit capacity begins to take effect. A relationship between a technological breakthrough rate and an equivalent research and development cost is established, which can generally be characterized by a piecewise linear function. Besides, an envelope uncertainty model is used to describe the uncertain relationship between the technological breakthrough rate and the research and development cost. Furthermore, considering the time benefit of the research and development cost, a specific model is as follows:

$${π}_{y}^{e q} = f ( {C}_{y}^{e q} ) \qquad ( 4 )$$

$${π}_{y} ∈ [ {π}_{y}^{e q} - σ , {π}_{y}^{e q} + σ ] \qquad ( 5 )$$

$${C}_{y + 1}^{e q} = {C}_{y}^{e q} θ + {c}_{y} \qquad ( 6 )$$

$$\{ \begin{matrix}{C}_{y + 1}^{e q} = {C}_{y}^{e q} θ + {c}_{y} , {π}_{y} < 1 \\ {C}_{y + 1}^{e q} = {c}_{y} , {π}_{y} \geq 1\end{matrix} \qquad ( 7 )$$

$$\{ \begin{matrix}{u}_{y} = 0 , {π}_{y} < 1 \\ {u}_{y} = 1 , {π}_{y} \geq 1\end{matrix} \qquad ( 8 )$$

In formula (4):

$${C}_{y}^{e q}$$

is an equivalent cumulative research and development investment, and

$${π}_{y}^{e q}$$

is a technological innovation breakthrough rate under the equivalent cumulative research and development investment. In formula (5): σ is a boundary indicator characterizing the uncertainty of technological innovation breakthrough rate, π_{y} is an actual technological innovation breakthrough rate considering the uncertainty. In formula (6): θ is a time benefit parameter of the research and development cost, c_{y} is a research and development investment portion newly added in the y-th year; and

$${C}_{y + 1}^{e q}$$

is an equivalent cumulative research and development investment in a (y+1)-th year.

Finally, according to the historical data, a differential evolution algorithm is used to solve the model parameters a, b, θ, and σ, aiming at minimizing the variance. Based on the data of future development situations of installed capacity scale and future research and development investment intensities for various types of energy sources, the investment cost per unit capacity of energy is predicted, which serves as equipment cost data for a capacity evolution sequence generation model.

Step S3: Construct a capacity evolution sequence generation model according to investment-cost-per-unit-capacity evolution prediction data output by the investment cost evolution model, the maximum allowable construction scale for equipment corresponding to various types of energy sources, the construction scale of currently constructed equipment, and the planned retirement time of the currently constructed equipment, where the capacity evolution sequence generation model adopts an objective function of minimizing a sum of an investment cost and a maintenance cost and takes equipment capacity connection constraints and capacity limit constraints as constraint conditions.

In practical applications, first, the maximum allowable construction scale for various types of equipment in the specific region, the construction scale of currently constructed equipment, and the planned retirement time of the currently constructed equipment are acquired.

Secondly, a capacity evolution sequence generation model is constructed, with an objective function of minimizing a sum of an investment cost and a maintenance cost, and with equipment capacity connection constraints and capacity limit constraints as constraint conditions. Input data of the model, in addition to the historical data in step S1, also includes the equipment cost data in step S2.

The objective function is as follows:

$$min {F}_{1} = min ( {F}^{inv} + {F}^{main} ) \qquad ( 9 )$$

$${F}^{inv} = {\sum }_{{Ω}^{kn}} {\sum }_{{Ω}^{y}} ( {c}_{kn , y}^{inv , p} {P}_{kn , y} + {c}_{kn , y}^{inv , e} {E}_{kn , y} ) - {F}^{sa} \qquad ( 10 )$$

$${F}^{sa} = {\sum }_{{Ω}^{k}} {ρ}_{k} ( {c}_{k , Y}^{unv , p} {P}_{k , Y} + {c}_{k , Y}^{inv , e} {E}_{k , Y} ) \frac{{H}_{k , Y}}{{T}_{k}} \qquad ( 11 )$$

$${H}_{k , Y} = \{ \begin{matrix}0 , & {Y}_{0} \leq ( Y - {T}_{k} + 1 ) \\ {T}_{k} - ( Y - {Y}_{0} + 1 ) , & {Y}_{0} > ( Y - {T}_{k} + 1 )\end{matrix} \qquad ( 12 )$$

$${F}^{main} = {\sum }_{{Ω}^{k}} {\sum }_{{Ω}^{y}} ( {c}_{k , y}^{main , p} {P}_{k , y} + {c}_{k , y}^{main , e} {E}_{k , y} ) \qquad ( 13 )$$

In formula (9): F₁ is a cost of the capacity evolution sequence generation model, mainly including an investment cost F^{inv} and a maintenance cost F^{main}. In formula (10):

$${c}_{kn , y}^{inv , p}$$

is investment costs per unit capacity of various types of energy devices;

$${c}_{kn , y}^{inv , e}$$

is investment costs per unit energy of various types of energy devices; P_{kn,y} and E_{kn,y} are an installed capacity and energy of newly added devices in a y-th year; F^{sa} is a residual value of non-retired devices within a planning period. In formula (11): ρₖ is a residual value recovery coefficient;

$${c}_{k , Y}^{inv , p} and {c}_{k , Y}^{inv , e}$$

are an investment cost per unit capacity and an investment cost per unit energy in a final year of the planning period; P_{k,Y} and E_{k,Y} are an installed capacity and energy in the final year of the planning period; H_{k,Y} is remaining lifespans of various types of energy devices at the end of the planning period; and Tₖ is service life of various types of energy devices. In formula (12): Y₀ is a time point when an energy device begins to be used. In formula (13):

$${c}_{k , y}^{main , p} and {c}_{k , y}^{m a i n , e}$$

are maintenance costs per unit capacity and maintenance costs per unit energy of various types of energy devices.

The constraint conditions include equipment capacity connection constraints and equipment capacity limit constraints. The equipment capacity connection constraints are as follows:

Initial equipment will be retired after reaching the operational lifespan, and energy devices installed in a certain stage will continue to operate in subsequent stages and will be retired after reaching their lifespans.

$${P}_{k , y} = {P}_{k , y - 1} + {P}_{kn , y} - {P}_{kr , y} \qquad ( 14 )$$

$${P}_{kr , y} = {P}_{k , y - {T}_{k}} , y - {T}_{k} \geq 1 \qquad ( 15 )$$

In formulas (14) to (15): P_{k,y} is an online installed capacity in a y-th year; P_{k,y-1} is an online installed capacity in a (y−1)-th year; P_{kn,y} is a newly added installed capacity at the beginning of the y-th year; P_{kr,y} is a retired installed capacity at the beginning of the y-th year; P_{k,y-T}_{ₖ} is an online installed capacity in a (y−Tₖ)-th year.

The equipment capacity limit constraints are as follows:

$${B}_{k , y} \leq {P}_{k , y} \leq {A}_{k , y} \qquad ( 16 )$$

In formula (16): B_{k,y} and A_{k,y} are a lower limit and an upper limit of the installed capacity of energy devices in the y-th year, respectively.

Step S4: Generate multiple operating scenarios of a power system by using a k-means clustering algorithm according to the relevant historical data.

In practical applications, electrical load in a specific region and historical data of actual operation of wind power output and photovoltaic output are acquired. For the historical data of wind power output and photovoltaic output, and the electrical load data, the historical data are divided into four parts according to the weather characteristics of the region: spring, summer, autumn, and winter. Taking one day as one cluster, multi-day data within each quarter are clustered into one cluster by using the k-means clustering algorithm, thereby obtaining four basic scenarios of power system operation. Based on this, electrical load prediction data of future years can also be obtained according to an electricity growth ratio.

Step S5: Construct a time-series production simulation model of the power system containing hydrogen long-duration energy storage according to a given capacity evolution sequence output by the capacity evolution sequence generation model and the multiple operating scenarios of the power system, where the time-series production simulation model of the power system takes carbon emission limit constraints and clean energy power generation share constraints as core constraints and adopts an objective function of minimizing a sum of an operating cost and a carbon trading cost.

In practical applications, under a given capacity evolution sequence, a time-series production simulation model of the power system containing hydrogen long-duration energy storage is constructed, with carbon emission limit constraints and clean energy power generation share constraints as core constraints. The objective function of this model is to minimize the sum of the operating cost and the carbon trading cost, and the constraint conditions mainly consist of electric energy module constraints, hydrogen energy module constraints, carbon module constraints, and driving factor constraints.

The objective function of the model is as follows:

$$min {F}_{2} = min ( {F}^{o m} + {F}^{c o} ) \qquad ( 17 )$$

$${F}^{o m} = {\sum }_{{Ω}^{k}} {\sum }_{{Ω}^{y}} {\sum }_{{Ω}^{s}} {\sum }_{{Ω}^{t}} ( {c}_{y}^{c o a l} {q}_{k , y , s , t}^{c o a l} + {c}_{y}^{g a s} {q}_{k , y , s , t}^{g a s} + {c}_{y}^{h y} {q}_{k , y , s , t}^{h y} ) Δ t + {C}_{k , y , s , t}^{U} + {C}_{k , y , s , t}^{D} \qquad ( 18 )$$

$${F}^{c o} = {\sum }_{{Ω}^{y}} {c}_{y}^{c o} \cdot {CO}_{y} \qquad ( 19 )$$

In formula (17): F₂ is a cost of the time-series production simulation model, mainly including an operating cost F^{om} and a carbon trading cost F^{co}. In formula (18):

$${q}_{k , y , s , t}^{c o a l} , {q}_{k , y , s , t}^{g a s} , and {q}_{k , y , s , t}^{h y}$$

are coal consumption, natural gas consumption, and hydrogen consumption, respectively;

$${c}_{y}^{c o a l} , {c}_{y}^{g a s} , and {c}_{y}^{h y}$$

are a cost per unit of coal consumption, a cost per unit of natural gas consumption, and a cost per unit of hydrogen consumption, respectively;

$${C}_{k , y , s , t}^{U} and {C}_{k , y , s , t}^{D}$$

are a startup cost and a shutdown cost of thermal power units (including coal-fired and gas-fired). In formula (19):

$${c}_{y}^{c o}$$

is a carbon trading price in a y-th year, and CO_{y} is a total carbon trading volume in the y-th year. In addition, Ω^{k} is a set of online energy devices; Ω^{kn} is a set of newly added devices; Ω^{kr} is a set of retired devices; Ω^{y} is a set of planning years; Ω^{s} is a set of operating scenarios; Ω^{t} is a set of daily operating times; and Δt is a time interval. This model considers 9 types of energy devices: Ω^{k-y} is a set of online energy devices of thermal power units, composed of coal-fired thermal power units Ω^{k-coal} and gas-fired thermal power units Ω^{k-gas}. Ω^{k-pv} is a set of online energy devices of photovoltaic units; Ω^{k-wind} is a set of online energy devices of wind power units; Ω^{k-ess} is a set of online energy devices of electrochemical energy storage devices; Ω^{k-el} is a set of online energy devices of electrolyzer devices; Ω^{k-fc} is a set of online energy devices of fuel cells; Ω^{k-ht} is a set of online energy devices of hydrogen storage tanks; and Ω^{k-ccs} is a set of online energy devices of carbon capture and storage devices.

The electric energy module constraints in the model include electrochemical energy storage operation constraints, coal-fired unit and gas-fired unit operation constraints, and wind power unit and photovoltaic unit operation constraints.

The electrochemical energy storage operation constraints are as follows:

$${p}_{k , y , s , t}^{ess} = {p}_{k , y , s , t}^{ess , out} - {p}_{k , y , s , t}^{ess , in} \qquad ( 20 )$$

$${p}_{k , y}^{ess , min} \leq {p}_{k , y , s , t}^{ess , in} , {p}_{k , y , s , t}^{ess , out} \leq {p}_{k , y}^{ess , max} \qquad ( 21 )$$

$${SOC}_{k , y , s , t}^{ess} = {SOC}_{k , y , s , t - 1}^{e s s} + ( {η}^{e s s , i n} {p}_{k , y , s , t}^{ess , in} - \frac{1}{{η}^{ess , out}} {p}_{k , y , s , t}^{ess , out} ) Δ t / {E}_{k , y}^{e s s} \qquad ( 22 )$$

$${SOC}_{k , y}^{ess , min} \leq {SOC}_{k , y , s , t}^{ess} \leq {SOC}_{k , y}^{ess , max} \qquad ( 23 )$$

$${C}_{k , y , s , {t}_{0}}^{ess} = {SOC}_{k , y , s , {t}_{N}}^{ess} \qquad ( 24 )$$

In formula (20):

$${p}_{k , y , s , t}^{e s s}$$

is an external output power of electrochemical energy storage, including an electrochemical energy storage charging power

$${p}_{k , y , s , t}^{ess , in}$$

and an electrochemical energy storage discharging power

$${p}_{k , y , s , t}^{ess , out} .$$

Formula (21) is upper and lower power limit constraints of electrochemical energy storage;

$${p}_{k , y}^{ess , min} and {p}_{k , y}^{ess , max}$$

are a lower limit and an upper limit of the electrochemical energy storage charging and discharging power. In formula (22):

$${SOC}_{k , y , s , t}^{e s s}$$

is a state of charge of electrochemical energy storage at time t;

$${E}_{k , y}^{e s s}$$

is rated energy of electrochemical energy storage; μ^{ess,in} and η^{ess,out} are charging efficiency and discharging efficiency of electrochemical energy storage;

$${SOC}_{k , y , s , t - 1}^{e s s}$$

is a state of charge of electrochemical energy storage at time t−1; k,y,s,t−1 represent a k-th device, a y-th year, an s-th operating scenario, and time t−1, respectively; t_{N} is an end time; t₀ is an initial time. In formula (23):

$${SOC}_{k , y}^{ess , min} and {SOC}_{k , y}^{ess , max}$$

are a minimum state of charge and a maximum state of charge of electrochemical energy storage. In formula (24):

$${SOC}_{k , y , s , {t}_{0}}^{e s s} and {SOC}_{k , y , s , {t}_{N}}^{e s s}$$

are a state of charge of the electrochemical energy storage device at the initial time and the end time within a daily dispatch cycle.

The coal-fired/gas-fired thermal power unit operation constraints are as follows:

$${p}_{k , y , s , t}^{coal} = {η}_{k , y}^{c o a l} {q}_{k , y , s , t}^{coal} \qquad ( 25 )$$

$${p}_{k , y , s , t}^{gas} = {η}_{k , y}^{gas} {q}_{k , y , s , t}^{gas} \qquad ( 26 )$$

$${\sum }_{x = t}^{t + TS - 1} ( 1 - {u}_{k , y , s , t} ) \geq TS ( {u}_{k , y , s , t - 1} - {u}_{k , y , s , t} ) \qquad ( 27 )$$

$${\sum }_{x = t}^{t + TO - 1} {u}_{k , y , s , t} \geq TO ( {u}_{k , y , s , t} - {u}_{k , y , s , t - 1} ) \qquad ( 28 )$$

$${C}_{k , y , s , t}^{D} \geq max \{ {U}_{k} ( {u}_{k , y , s , t} - {u}_{k , y , s , t - 1} ) , 0 \} \qquad ( 29 )$$

$${C}_{k , y , s , t}^{D} \geq max \{ {D}_{k} ( {u}_{k , y , s , t - 1} - {u}_{k , y , s , t} ) , 0 \} \qquad ( 30 )$$

$${u}_{k , y , s , t} {α}_{k , y}^{min} {P}_{k , y}^{g} \leq {p}_{k , y , s , t}^{g} \leq {u}_{k , y , s , t} {α}_{k , y}^{max} {P}_{k , y}^{g} \qquad ( 31 )$$

$$( 1 - ( {u}_{k , y , s , t} - {u}_{k , y , s , t - 1} ) ) ( {p}_{k , y , s , t}^{g} - {p}_{k , y , s , t - 1}^{g} ) \leq {r}_{k , y} {u}_{k , y , s , t} {P}_{k , y}^{g} \qquad ( 32 )$$

$$( 1 - ( {u}_{k , y , s , t - 1} - {u}_{k , y , s , t} ) ) ( {p}_{k , y , s , t - 1}^{g} - {p}_{k , y , s , t}^{g} ) \leq {d}_{k , y} {u}_{k , y , s , t} {P}_{k , y}^{g} \qquad ( 33 )$$

In formulas (25) to (26):

$${p}_{k , y , s , t}^{coal} and {p}_{k , y , s , t}^{gas}$$

are an output electric power of the coal-fired thermal power units and an output electric power of the gas-fired thermal power units;

$${η}_{k , y}^{coal} and {η}_{k , y}^{gas}$$

are fuel-to-power conversion coefficients of the coal-fired thermal power units and the gas-fired thermal power units;

$${q}_{k , y , s , t}^{c o a l}$$

is an input coal amount of the coal-fired thermal power units; and

$${q}_{k , y , s , t}^{gas}$$

is an input natural gas amount of the gas-fired thermal power units. In formulas (27) to (30): u_{k,y,s,t-1} is an on/off status of the thermal power units at time t−1;

$${C}_{k , y , s , t}^{U}$$

is a startup cost of the thermal power units at time t;

$${C}_{k , y , s , t}^{D}$$

is a shutdown cost of the thermal power units at time t; u_{k,y,s,t} is an on/off status of the thermal power units at time t; TS and TO are a minimum shutdown time and a minimum operating time of the thermal power units; Uₖ and Dₖ are a single startup cost and a single shutdown cost of the thermal power units. In formulas (31) to (33):

$${p}_{k , y , s , t}^{g}$$

is an output power of the thermal power units at time t;

$${P}_{k , y}^{g}$$

is an installed capacity of the thermal power units;

$${p}_{k , y , s , t - 1}^{g}$$

is an output power of the thermal power units at time t−1;

$${α}_{k , y}^{min} and {α}_{k , y}^{max}$$

are a minimum technical output and a maximum technical output of the thermal power units; r_{k,y} and d_{k,y} are an upward ramp rate and a downward ramp rate of the thermal power units.

The wind power/photovoltaic unit operation constraints are as follows:

$$0 \leq {p}_{k , y , s , t}^{wind} \leq {p}_{k , y , s , t}^{wind , ipre} \leq {P}_{k , y}^{wind} \qquad ( 34 )$$

$$0 \leq {p}_{k , y , s , t}^{p v} \leq {p}_{k , y , s , t}^{pv , ipre} \leq {P}_{k , y}^{p v} \qquad ( 35 )$$

In formulas (34)-(35):

$${p}_{k , y , s , t}^{w i n d} and {p}_{k , y , s , t}^{p v}$$

are actual output electric powers of wind power units and photovoltaic units;

$${p}_{k , y , s , t}^{w i nd , ipre} and {p}_{k , y , s , t}^{pv , ipre}$$

are predicted electric powers of the wind power units and the photovoltaic units;

$${P}_{k , y}^{w i n d} and {P}_{k , y}^{p v}$$

are installed capacities of the wind power units and the photovoltaic units.

The energy storage function of the hydrogen energy storage system is the same as that of other energy storage equipment such as batteries. When the wind and photovoltaic output power exceeds the load demand, electrolyzers are used to consume the surplus electrical energy, produce hydrogen through water electrolysis, and store the hydrogen in hydrogen storage tanks, which is equivalent to increasing the electrical load; when the wind and photovoltaic output power is less than the load demand, fuel cells generate electrical energy to meet the load demand, improving the reliability of the system. The hydrogen energy module constraints include an electrolyzer operation model, a fuel cell operation model, and a hydrogen storage tank operation model.

The electrolyzer operation model is as follows:

$${q}_{k , y , s , t}^{el , out} = {η}_{k , y}^{e l} {p}_{k , y , s , t}^{el , i n} \qquad ( 36 )$$

$${p}_{k , y , s , t}^{el , i n , max} = min ( {P}_{k , y}^{e l} , \frac{{E}_{k , y}^{ht , max} - {E}_{k , y , s , t}^{h t}}{{η}_{k , y}^{e l} Δ t} ) \qquad ( 37 )$$

$$0 \leq {p}_{k , y , s , t}^{el , i n} \leq {p}_{k , y , s , t}^{el , i n , max} \qquad ( 38 )$$

$${E}_{k , y}^{ht , max} = {SOC}_{k , y}^{ht , max} {E}_{k , y}^{ht} \qquad ( 39 )$$

In formula (36):

$${q}_{k , y , s , t}^{el , out}$$

is an output hydrogen quantity of an electrolyzer device,

$${p}_{k , y , s , t}^{el , i n}$$

is an input electric power of the electrolyzer device, and

$${η}_{k , y}^{e l}$$

is an electric-to-hydrogen conversion coefficient of the electrolyzer device. In formula (37):

$${p}_{k , y , s , t}^{el , i n , max}$$

is a maximum input electric power of the electrolyzer device, depending on an installed capacity

$${P}_{k , y}^{e l}$$

of the electrolyzer device and the status of the hydrogen storage tank;

$${E}_{k , y}^{ht , max}$$

is a maximum hydrogen storage amount of the hydrogen storage tank; and

$${E}_{k , y , s , t}^{ht}$$

is an actual hydrogen storage status of the hydrogen storage tank. In formula (39):

$${SOC}_{k , y}^{ht , max}$$

is a maximum state of charge of the hydrogen storage tank, and

$${E}_{k , y}^{ht}$$

is rated energy of the hydrogen storage tank.

The fuel cell operation model is as follows:

$${p}_{k , y , s , t}^{fc , out} = {η}_{k , y}^{fc} {q}_{k , y , s , t}^{fc , in} \qquad ( 40 )$$

$${p}_{k , y , s , t}^{fc , out , max} = min ( {P}_{k , y}^{fc} , \frac{{E}_{k , y , s , t}^{ht} {E}_{k , y}^{ht , min}}{Δ t} {η}_{k , y}^{fc} ) \qquad ( 41 )$$

$$0 \leq {p}_{k , y , s , t}^{fc , out} \leq {p}_{k , y , s , t}^{fc , out , max} \qquad ( 42 )$$

$${E}_{k , y}^{ht , min} = {SOC}_{k , y}^{ht , min} {E}_{k , y}^{ht} \qquad ( 43 )$$

In formula (40):

$${p}_{k , y , s , t}^{fc , out}$$

is an output electric power of a fuel cell,

$${q}_{k , y , s , t}^{fc , in}$$

is input hydrogen consumption of the fuel cell, and

$${η}_{k , y}^{fc}$$

is a hydrogen-to-electric conversion coefficient of the fuel cell. In formula (41):

$${p}_{k , y , s , t}^{fc , out , max}$$

is a maximum output electric power of the fuel cell, depending on an installed capacity

$${P}_{k , t}^{fc}$$

of the fuel cell and the status of the hydrogen storage tank, and

$${E}_{k , y}^{ht , min}$$

is a minimum hydrogen storage amount of the hydrogen storage tank. In formula (43):

$${SOC}_{k , y}^{ht , min}$$

is a minimum state of charge of the hydrogen storage tank.

The hydrogen storage tank operation model is as follows:

$${E}_{k , y , s , t}^{ht} = {E}_{k , y , s , t}^{ht} + ( {q}_{k , y , s , t - 1}^{el , out} Δ t + {q}_{k , y , s , t - 1}^{h y} Δ t ) {η}_{k , y}^{ht} \qquad ( 44 )$$

$${E}_{k , y , s , t}^{ht} = {E}_{k , y , s , t - 1}^{ht} - \frac{{q}_{k , y , s , t}^{fc , in}}{{η}_{k , y}^{h t}} Δ t \qquad ( 45 )$$

$${E}_{k , t}^{ht , min} \leq {E}_{k , y , s , t}^{ht} \leq {E}_{k , y}^{ht , max} \qquad ( 46 )$$

$${SO C}_{k , y , {s}_{0} , {t}_{0}}^{ht} = {SOC}_{k , y , {s}_{N} , {t}_{N}}^{ht} \qquad ( 47 )$$

Formula (44) is a relationship during hydrogen storage in the hydrogen storage tank, where

$${E}_{k , y . s , t - 1}^{ht}$$

is a hydrogen storage amount of the hydrogen storage tank at time t−1;

$${q}_{k , y , s , t - 1}^{el , out}$$

is an output hydrogen quantity of the electrolyzer device at time t−1; Δt is a time interval;

$${q}_{k , y , s , t - 1}^{h y}$$

is hydrogen consumption at time t−1. Formula (45) is a relationship during hydrogen release from the hydrogen storage tank, where

$${η}_{k , y}^{ht}$$

is hydrogen charging/discharging efficiency of the hydrogen storage tank.

$${E}_{k , y}^{ht , max}$$

is a maximum hydrogen storage amount of the hydrogen storage tank. In formula (47):

$${SOC}_{k , y , {s}_{0} , {t}_{0}}^{ht} and {SOC}_{k , y , {s}_{N} , {t}_{N}}^{ht}$$

are an initial state of charge and a final state of charge of the hydrogen storage tank within an annual dispatch cycle. s₀ is an initial scenario of hydrogen storage tank operation; s_{N} is a final scenario of hydrogen storage tank operation. To ensure the continuous and effective operation of the hydrogen energy storage system, the state of charge of the hydrogen storage tank at the beginning and end of the dispatch cycle should be equal.

The carbon module consists of carbon trading cost and a carbon capture and storage (CCS) device.

The carbon trading cost has been explained in formula (19). Carbon trading is essentially a trading mechanism that achieves carbon emission reduction through buying and selling carbon emission quotas.

The process of the CCS device capturing carbon dioxide emitted by thermal power units is as follows, where a set g includes coal-fired and gas-fired thermal power units.

$${x}_{k , y , s , t}^{g} = {δ}_{y}^{g} {q}_{k , y , s , t}^{g} \qquad ( 48 )$$

$${x}_{k , y , s , t}^{ccs} + {x}_{k , y , s , t}^{ccs , cur} = {η}_{k , y}^{ccs} {x}_{k , y , s , t}^{g} \qquad ( 49 )$$

$${p}_{k , y , s , t}^{c c s} = {λ}_{k , y}^{ccs} {x}_{k , y , s , t}^{ccs} \qquad ( 50 )$$

$$0 \leq {p}_{k , y , s , t}^{c c s} \leq {P}_{k , y}^{c c s} \qquad ( 51 )$$

In formula (48):

$${q}_{k , y , s , t}^{g}$$

is energy consumption of the thermal power units,

$${δ}_{y}^{g}$$

is a carbon emission amount per unit energy consumption, and

$${x}_{k , y , s , t}^{g}$$

is a carbon emission amount generated by the thermal power units. In formula (49):

$${η}_{k , y}^{ccs}$$

is capture efficiency of the CCS device,

$${x}_{k , y , s , t}^{ccs}$$

is an actual capture amount of the CCS device, and

$${x}_{k , y , s , t}^{ccs , cur}$$

is a dissipation amount during the capture process of the CCS device. In formulas (50) to (51):

$${p}_{k , y , s , t}^{c c s}$$

is actual power consumption of the CCS device,

$${P}_{k , y}^{c c s}$$

is an installed capacity of the CCS device, and

$${λ}_{k , y}^{ccs}$$

is a power consumption coefficient of the CCS device.

The driving factor constraints include clean energy power generation share constraints, carbon emission limit constraints, and power balance constraints.

The clean energy power generation share constraints are as follows:

$$\frac{{\sum }_{{Ω}^{s}} {\sum }_{{Ω}^{t}} [ {\sum }_{{Ω}^{k - wind}} ( {p}_{k , y , s , t}^{w i n d} Δ t ) + {\sum }_{{Ω}^{k - p ν}} ( {p}_{k , y , s , t}^{p v} Δ t ) + {\sum }_{{Ω}^{k - f c}} ( {p}_{k , y , s , t}^{fc , out} Δ t ) - {\sum }_{{Ω}^{k - e l}} ( {p}_{k , y , s , t}^{el , i n} Δ t ) ]}{{\sum }_{{Ω}^{s}} {\sum }_{{Ω}^{t}} ( {p}_{y , s , t}^{l o a d} Δ t )} \geq {γ}_{y}^{n e w} \qquad ( 52 )$$

In formula (52),

$${p}_{y , s , t}^{l o a d}$$

is an electrical load in the region, and

$${γ}_{y}^{n e w}$$

is a minimum clean energy power generation share parameter.

For the carbon emission limit constraints, there are mainly two paths: the first is a steady annual restriction, and the other is a total amount restriction.

$${X}_{y} = {\sum }_{{Ω}^{k - g}} {\sum }_{{Ω}^{s}} {\sum }_{{Ω}^{t}} {δ}_{y}^{g} {q}_{k , y , s , t}^{g} Δ t - {\sum }_{{Ω}^{k - c c s}} {\sum }_{{Ω}^{s}} {\sum }_{{Ω}^{t}} {x}_{k , y , s , t}^{c c s} Δ t - {CO}_{y} \qquad ( 53 )$$

$${X}_{y} \leq {X}_{b a s e} {σ}_{y} \qquad ( 54 )$$

$${\sum }_{{Ω}^{y}} {X}_{y} \leq {X}_{b a s e , a} {σ}_{a} \qquad ( 55 )$$

In formulas (53) to (55): X_{y} is an equivalent carbon emission amount of the region in a y-th year; X_{base} is a base carbon emission amount for a single year; σ_{y} is a carbon emission limit parameter in the y-th year; X_{base,a} is a total base carbon emission amount within a planning period; and σₐ is a total carbon emission limit parameter within the planning period.

The power balance constraints are as follows: In any scenario and any time period, the sum of power source outputs should equal the total electrical load.

$${\sum }_{{Ω}^{k}} ( {p}_{k , y , s , t}^{c o a l} + {p}_{k , y , s , t}^{g a s} + {p}_{k , y , s , t}^{w i n d} + {p}_{k , y , s , t}^{p v} + {p}_{k , y , s , t}^{fc , out} + {p}_{k , y , s , t}^{e s s} - {p}_{k , y , s , t}^{el , i n} - {p}_{k , y , s , t}^{c c s} ) = {p}_{y , s , t}^{l o a d} \qquad ( 56 )$$

Finally, the objective function is redefined according to weights of the basic scenarios. The objective function is re-expressed as:

$$min {F}_{2} = min ( {\sum }_{{Ω}^{s}} {τ}_{s} ( {f}_{s}^{i n v} + {f}_{s}^{m a i n} + {f}_{s}^{on} + {f}_{s}^{c o} ) ) = min ( {\sum }_{{Ω}^{s}} {τ}_{s} {F}_{s} ) \qquad ( 57 )$$

Formula (57): τₛ is weight coefficients of various operating scenarios;

$${f}_{s}^{o m} and {f}_{s}^{c o}$$

are an operating cost and a carbon trading cost under an s-th scenario, respectively; Fₛ is a sum of the operating cost and the carbon trading cost under the s-th scenario.

Step S6: Construct a data-model hybrid-driven model capable of measuring system cleanliness and low-carbon performance by using CNN-BiGRU-AM, based on the capacity evolution sequence generation model and the time-series production simulation model of the power system containing hydrogen long-duration energy storage, where the data-model hybrid-driven model takes the capacity evolution sequence output by the capacity evolution sequence generation model as input and takes a corresponding marginal cost of electricity share and a corresponding marginal cost of carbon allowances as output.

S6 specifically includes:

Step S61: Apply a random function to generate a random capacity evolution sequence based on the capacity evolution sequence generation model.

Step S62: Input the random capacity evolution sequence into the time-series production simulation model of the power system containing hydrogen long-duration energy storage to obtain a minimized sum of the operating cost and the carbon trading cost.

Step S63: Calculate the corresponding marginal cost of electricity share and marginal cost of carbon allowances by adjusting clean energy power generation share or a carbon emission limit, with reference to the minimized sum of the operating cost and the carbon trading cost.

Step S64: With the random capacity evolution sequence as input and the corresponding marginal cost of electricity share and the corresponding marginal cost of carbon allowances as output, train the CNN-BiGRU-AM to obtain the data-model hybrid-driven model capable of measuring system cleanliness and low-carbon performance.

In practical applications, first, the clean energy power generation share and carbon emission limit are taken as specific indicators to measure the cleanliness and low-carbon performance of the power system considering hydrogen long-duration energy storage. Based on an expected clean energy power generation share path and an expected annual carbon emission limit path, by appropriately increasing the clean energy power generation share and reducing the carbon emission limit, a relationship between economic cost and path changes is studied.

$${χ}_{y}^{n e w} = \frac{Δ {F}_{2}}{Δ {γ}_{y}^{n e w}} \qquad ( 58 )$$

$${χ}_{y}^{c o} = \frac{Δ {F}_{2}}{{Δσ}_{y}} \qquad ( 59 )$$

In formulas (58) to (59): ΔF₂ is a change in the operating cost and carbon trading cost;

$$Δ {γ}_{y}^{n e w}$$

is a change in the clean energy power generation share; Δσ_{y} is a change in the carbon emission limit;

$${χ}_{y}^{n e w}$$

is the marginal cost of electricity share; and

$${χ}_{y}^{c o}$$

is the marginal cost of carbon allowances.

Secondly, based on the capacity evolution sequence generation model and the time-series production simulation model of the power system containing hydrogen long-duration energy storage, CNN-BiGRU-AM is used to construct a data-model hybrid-driven model capable of measuring system cleanliness and low-carbon performance. The CNN-BiGRU-AM model helps extract hidden spatiotemporal features in capacity evolution sequence data. The attention mechanism guides the model to prioritize relevant input data features, enhancing the robustness of the model.

The specific process is as follows: In the first step, a random function is used to continuously generate random capacity evolution sequences based on the capacity evolution sequence generation model. In the second step, the random capacity evolution sequences are input into the time-series production simulation model of the power system containing hydrogen long-duration energy storage to obtain the minimized sum of the operating cost and the carbon trading cost, and then the clean energy power generation share is appropriately increased or the carbon emission limit is appropriately decreased to calculate the marginal cost of electricity share and the marginal cost of carbon allowances. In the third step, a massive dataset is constructed, and the random capacity evolution sequences, marginal cost of electricity share, and marginal cost of carbon allowances are input into the CNN-BiGRU-AM model to continuously train the model. In the fourth step, after the training is completed, by inputting a capacity evolution sequence into the CNN-BiGRU-AM model, the corresponding marginal cost of electricity share and marginal cost of carbon allowances can be quickly obtained.

Step S7: Construct a low-carbon evolution path simulation model of the power system according to the marginal cost of electricity share, the marginal cost of carbon allowances, the minimized sum of the investment cost and the maintenance cost, and the minimized sum of the operating cost and the carbon trading cost, where the low-carbon evolution path simulation model of the power system considers hydrogen long-duration energy storage and involves economic cost driving factors, clean energy power generation share driving factors, and carbon emission limit driving factors.

In practical applications, considering the economic cost driving factors, clean energy power generation share driving factors, and carbon emission limit driving factors, corresponding driving models are constructed.

An economic cost driving model is constructed as follows:

$${V}^{F} = {\sum }_{{Ω}^{s}} {τ}_{s} [ {z}_{s}^{F} \cdot {v}^{+} ( {F}_{s} ) + ( 1 - {z}_{s}^{F} ) \cdot {v}^{-} ( {F}_{s} ) ] \qquad ( 60 )$$

$${v}^{+} ( {F}_{s} ) = - ( {F}_{0} - {F}_{s} - {F}_{1} ) , {F}_{0} > {F}_{s} + {F}_{1} \qquad ( 61 )$$

$${v}^{-} ( {F}_{s} ) = ζ ( {F}_{s} + {F}_{1} - {F}_{0} ) , {F}_{s} + {F}_{1} \geq {F}_{0} \qquad ( 62 )$$

In formulas (60) to (62),

$${z}_{S}^{F}$$

is an economic cost probability coefficient; Fₛ is a sum of an operating cost and a carbon trading cost under an s-th scenario; step S3 outputs the minimized sum of the investment cost and the maintenance cost, and step S6 outputs the minimized sum of the operating cost and the carbon trading cost based on the expected clean energy power generation share path and the expected annual carbon emission limit path; F₀ is a total of the minimized sum of the investment cost and the maintenance cost and the minimized sum of the operating cost and the carbon trading cost. ζ is a driving coefficient.

A clean energy power generation share driving model and a carbon emission limit driving model are constructed.

$${V}^{n e w} = {\sum }_{{Ω}^{y}} {χ}_{y}^{n e w} [ {z}_{y}^{n e w} \cdot {v}^{+} ( {γ}_{y} ) + ( 1 - {z}_{y}^{n e w} ) \cdot {v}^{-} ( {γ}_{y} ) ] \qquad ( 63 )$$

$${v}^{+} ( {γ}_{y} ) = - ( {γ}_{y} - {γ}_{y , 0} ) , {γ}_{y} > {γ}_{y , 0} \qquad ( 64 )$$

$${v}^{-} ( {γ}_{y} ) = ζ ( {γ}_{y , 0} - {γ}_{y} ) , {γ}_{y , 0} \geq {γ}_{y} \qquad ( 65 )$$

In formulas (64) to (65):

$${z}_{y}^{n e w}$$

is a clean energy power generation share probability coefficient; γ_{y} is a clean energy power generation share in a y-th year; and γ_{y,0} is a clean energy power generation share reference parameter in the y-th year.

$${V}^{c o} = {\sum }_{{Ω}^{y}} {χ}_{y}^{c o} [ {z}_{y}^{c o} \cdot {v}^{+} ( {σ}_{y} ) + ( 1 - {z}_{y}^{c o} ) \cdot {v}^{-} ( {σ}_{y} ) ] \qquad ( 66 )$$

$${v}^{+} ( {σ}_{y} ) = - ( {σ}_{y , 0} - {σ}_{y} ) , {σ}_{y , 0} > {σ}_{y} \qquad ( 67 )$$

$${v}^{-} ( {σ}_{y} ) = ζ ( {σ}_{y} - {σ}_{y , 0} ) , {σ}_{y} \geq {σ}_{y , 0} \qquad ( 68 )$$

In formulas (67) to (68):

$${z}_{y}^{c o}$$

is a carbon emission limit probability coefficient; σ_{y} is a carbon emission limit in a y-th year; σ_{y,0} is a carbon emission limit reference parameter in the y-th year.

Secondly, the objective function of the low-carbon evolution path simulation model of the power system considering hydrogen long-duration energy storage is expressed as follows:

$$V = {ω}^{F} {V}^{F} + {ω}^{n e w} {V}^{n e w} + {ω}^{c o} {V}^{c o} \qquad ( 69 )$$

In formula (69): V is a comprehensive benefit cost value; V^{F}, V^{new}, and V^{co} are benefit cost values under an economic cost driver, a clean energy power generation share driver, and a carbon emission limit driver, respectively; ω^{F}, ω^{new} and ω^{co} are weight coefficients under the economic cost driver, clean energy power generation share driver, and carbon emission limit driver, respectively.

Step S8: Construct a two-layer solution framework according to the low-carbon evolution path simulation model of the power system, where the two-layer solution framework includes a capacity layer and an operation layer and has an objective of minimizing a comprehensive benefit cost, the capacity layer adopts a Proportional-Integral-Derivative (PID) search algorithm, and the operation layer adopts an improved differential evolution algorithm to obtain a low-carbon evolution path of the power system considering hydrogen long-duration energy storage.

In practical applications, the low-carbon evolution path simulation model of the power system considering hydrogen long-duration energy storage performs relaxation transformation on the clean energy power generation share constraints and carbon emission limit constraints, that is, through the marginal cost of electricity share and the marginal cost of carbon allowances, the clean energy power generation share constraints and the carbon emission limit constraints are converted into the clean energy power generation share driving model and the carbon emission limit driving model, and the constraint conditions are transferred to the objective function part, achieving model relaxation. Therefore, the constraint conditions of the model do not include the clean energy power generation share constraints and carbon emission limit constraints, and other constraint conditions remain consistent with those of the capacity evolution sequence generation model and the production simulation model of the power system containing hydrogen long-duration energy storage.

For the established low-carbon evolution path simulation model of the power system considering hydrogen long-duration energy storage, based on a hierarchical optimization idea, a double-layer solution framework is constructed for hierarchical solution, aiming at minimizing the comprehensive benefit cost. The model can be divided into two parts: a capacity layer and an operation layer. The capacity layer adopts a PID search algorithm, and the operation layer adopts an improved differential evolution algorithm for solution.

In the capacity layer, a PID search algorithm is used for solution. The PID search algorithm is based on an incremental PID algorithm, and by continuously adjusting the system deviation, the entire population converges to the optimal state.

$${e}_{k} ( t ) = {x}^{*} ( t - 1 ) - x ( t - 1 ) \qquad ( 70 )$$

$$Δ u ( t ) = {K}_{p} {r}_{2} [ {e}_{k} ( t ) - {e}_{k - 1} ( t ) ] + {K}_{i} {r}_{3} {e}_{k} ( t ) + {K}_{d} {r}_{4} [ {e}_{k} ( t ) - 2 {e}_{k - 1} ( t ) + {e}_{k - 2} ( t ) ] \qquad ( 71 )$$

$$x ( t + 1 ) = x ( t ) + ξΔ u ( t ) + ( 1 - ξ ) o ( t ) \qquad ( 72 )$$

In formulas (70) to (72): eₖ(t) is an overall deviation at a t-th iteration; x(t) is a population state at the t-th iteration; x*(t) is a best state when the iteration count is t, which is a state of an overall historical minimum value; x*(t−1) is a best state at a (t−1)-th iteration; x(t−1) is a population state at the (t−1)-th iteration; x(t+1) is a population state at a (t+1)-th iteration; eₖ₋₁(t) is an overall deviation of a previous iteration when the iteration count is t; eₖ₋₂(t) is an overall deviation of the previous two iterations when the iteration count is t; r₂, r₃, and r₄ are random numbers; Kₚ, Kᵢ, and K_{d} are proportional, integral, and derivative coefficients, respectively; Δu(t) is an output value of PID adjustment; o(t) is a zero output condition factor; and ξ is a random number.

In the operation layer, an improved differential evolution algorithm is used for solution. The entire population is randomly divided into two sub-populations, which adopt different mutation strategies to accelerate the algorithm optimization speed and improve the algorithm optimization performance.

$${v}_{i , G} = {x}_{i , G} + F \cdot ( {x}_{pbest , G} - {x}_{i , G} ) + F \cdot ( {x}_{{r}_{1} , G} - {x}_{{r}_{2} , G} ) \qquad ( 73 )$$

$${v}_{i , G} = {x}_{i , G} + F \cdot ( {x}_{{r}_{1} , G} - {x}_{i , G} ) + F \cdot ( {x}_{{r}_{2} , G} - {x}_{{r}_{3} , G} ) \qquad ( 74 )$$

$${u}_{i , j , G} = \{ \begin{matrix}{v}_{i , j , G} , rand ( j ) \leq CR \\ {x}_{i , j , G} , rand ( j ) > CR\end{matrix} \qquad ( 75 )$$

$${x}_{i , G + 1} = \{ \begin{matrix}{u}_{i , G} , f ( {u}_{i , G} ) < f ( {x}_{i , G} ) \\ {x}_{i , G} , f ( {u}_{i , G} ) \geq f ( {x}_{i , G} )\end{matrix} \qquad ( 76 )$$

In formulas (73) to (76): x_{i,G} is an i-th population individual; G is the population generation; v_{i,G} is a mutated population individual; xᵣ_{₁}_{,G}, xᵣ_{_{2,G}}, and xᵣ_{_{3,G}} are three different random individuals in the population; x_{pbest,G} is randomly selected from the top p high-performing individuals in the current population; F is a scaling factor; CR is a crossover probability; rand(j) is a random number; v_{i,j,G} is a j-th element of the mutated population individual; x_{i,j,G} is a j-th element of an i-th population individual; u_{i,G} is a population individual obtained after crossover; f(u_{i,G}) and f(x_{i,G}) are the fitness of u_{i,G} and x_{i,G}, respectively; u_{i,j,G} is a j-th element of the population individual obtained after crossover; V_{i,jG} is a j-th element of the mutated population individual; x_{i,G+1} is an i-th population individual of a (G+1)-th generation.

When performing the operation simulation part, first, based on the capacity configuration results transmitted from the capacity layer, initial parameters are set, population initialization is performed, individual fitness values are calculated, and the optimal value is recorded. Then, the entire population is randomly divided into two sub-populations, which adopt different mutation strategies, namely formulas (73) to (74), and perform corresponding mutations for each sub-population; perform crossover operation according to formula (75); compare the trial individual with the target individual according to formula (76), record the optimal value, and judge whether the convergence accuracy is met or the iteration count is reached. If the termination condition is not met, perform population random division, mutation operation, and crossover operation again; when stopping, output x_{i,G+1}, to obtain the optimal result of the operation simulation part under the current energy device capacity configuration.

Based on the aforementioned two algorithms, building upon the initial installed capacities of various types of energy devices, population initialization for the installed capacities of online energy devices is first performed using the PID search algorithm. Subsequently, the system error is calculated, where the objective during calculation of the system error is to minimize the comprehensive benefit cost. Based on the installed capacities of the online devices, the investment cost and maintenance cost can be calculated. The operation layer needs to be invoked for chronological production simulation, which returns the optimal operating cost, carbon trading cost, clean energy power generation share, and carbon emission limit from the operation layer. Finally, through continuous adjustment of the system capacity evolution sequence, the PID search algorithm enables the entire population to converge to an optimal state, outputting an evolution scheme for the clean energy power generation share path and carbon emission limit path.

The present disclosure has the following innovative points:

(1) The investment cost evolution model considering the uncertainty of technological innovation breakthrough rate disclosed in the present disclosure can predict the investment costs per unit capacity of various types of typical equipment.

(2) The present disclosure applies a data-model hybrid-driven method based on CNN-BiGRU-AM, achieving rapid measurement of system cleanliness and low-carbon performance.

(3) The present disclosure determines the low-carbon evolution path simulation model of the power system considering hydrogen long-duration energy storage based on the capacity evolution sequence generation model and the time-series production simulation model of the power system containing hydrogen long-duration energy storage, and relaxes the core constraints.

(4) The present disclosure uses a PID search algorithm and an improved differential evolution algorithm to solve the low-carbon evolution path simulation model of the power system.

The present disclosure has the following advantages:

(1) The present disclosure constructs an energy device investment cost evolution model considering the uncertainty of technological innovation breakthrough rate. This model has an excellent fitting effect on historical data of the investment cost and can improve the prediction accuracy of the investment cost per unit capacity of energy devices.

(2) Based on the CNN-BiGRU-AM neural network model, the present disclosure constructs a data-model hybrid-driven model capable of measuring system cleanliness and low-carbon performance, which can quickly obtain the equivalent benefits of cleanliness and low-carbon performance under different capacity evolution sequences.

(3) The present disclosure constructs a capacity evolution sequence generation model and a time-series production simulation model of the power system containing hydrogen long-duration energy storage, performs accurate modeling of the electric energy, hydrogen energy, and carbon quantity parts, and effectively reduces the operating scenarios, thereby providing an effective means for the capacity evolution of energy devices in the power system, and enhancing the solvability of the model. Meanwhile, after considering the role of hydrogen long-duration energy storage, it can effectively reduce the economic cost of energy device configuration. Further, a low-carbon evolution path simulation model of the power system considering hydrogen long-duration energy storage is constructed, providing a model basis for evolution path optimization simulation.

(4) The present disclosure uses a double-layer solution framework based on a PID search algorithm and an improved differential evolution algorithm to solve the low-carbon evolution path simulation model of the power system considering hydrogen long-duration energy storage, thereby effectively improving the global search ability and convergence speed of the algorithm, and achieving high search efficiency and fast solution speed.

(5) The present disclosure provides an effective means for the power supply structure evolution and power supply capacity construction arrangement of the power system, taking into account economy, low-carbon performance, and cleanliness, and effectively improving the comprehensive benefit of the power system. The formed evolution path takes into account economy, low-carbon performance, and cleanliness, provides directional guidance for power supply construction in the power system, effectively reduces capacity configuration costs, and improves the utilization rate of new energy and the cleanliness and low-carbon level of the power system.

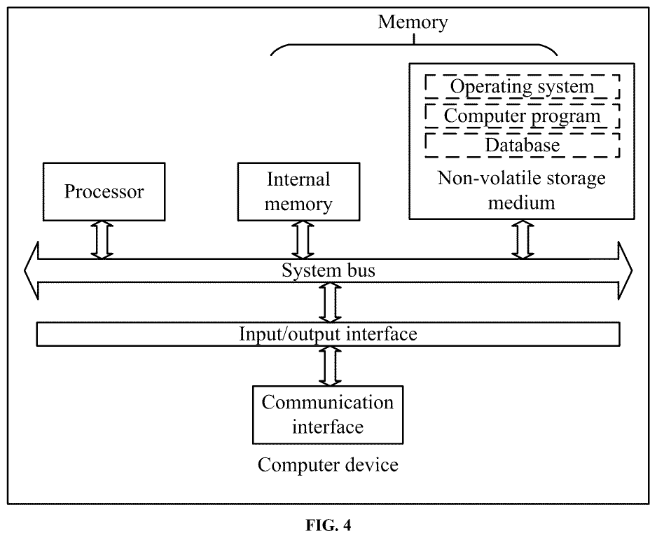

In an embodiment, a computer device is provided. The computer device may be a server or a terminal, and an internal structure thereof may be as shown in FIG. 4. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer apparatus includes a nonvolatile storage medium, and an internal memory. The non-volatile storage medium stores an operating system, a computer program, and a database. The internal memory provides an environment for operations of the operating system and the computer program in the non-volatile storage medium. The database of the computer device is configured to store simulation data of a low-carbon evolution path of a power system. The input/output interface of the computer apparatus is configured to exchange information between the processor and an external apparatus. The communication interface of the computer apparatus is configured to communicate with an external terminal through a network. The computer program, when executed by a processor, implements a method for simulating a low-carbon evolution path of a power system.

Those skilled in the art may understand that the structure shown in FIG. 4 is only a block diagram of a part of the structure related to the solutions of the present disclosure and does not constitute a limitation on a computer device to which the solutions of the present disclosure are applied. Specifically, the computer device may include more or less components than those shown in the figure, or combine some components, or have different component arrangements. In an embodiment, a computer device is provided, including a memory and a processor, where the memory stores a computer program, and the computer program is executed by the processor to implement the steps of the above method embodiment.

In an embodiment, a computer-readable storage medium is provided. The computer-readable storage medium stores a computer program, and the computer program is executed by a processor to implement the steps of the above method embodiment.

In an embodiment, a computer program product is provided. The computer program product includes a computer program, and the computer program is executed by a processor to implement the steps of the above method embodiment.

It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory.

The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A method for simulating a low-carbon evolution path of a power system, comprising:
acquiring relevant historical data on energy costs in a target region, future planning data of the target region, a maximum allowable construction scale for equipment corresponding to various types of energy sources in the target region, a construction scale of currently constructed equipment in the target region, and planned retirement time of the currently constructed equipment in the target region, wherein the future planning data comprises future planned installed capacities and future planned research and development investments for the various types of energy sources; the relevant historical data comprises installed capacities, research and development investments, and investment costs per unit capacity of the various types of energy sources over years;
constructing an investment cost evolution model considering uncertainty of technological innovation breakthrough rate according to the relevant historical data and the future planning data;
constructing a capacity evolution sequence generation model according to investment-cost-per-unit-capacity evolution prediction data output by the investment cost evolution model, the maximum allowable construction scale for equipment corresponding to the various types of energy sources, the construction scale of currently constructed equipment, and the planned retirement time, wherein the capacity evolution sequence generation model adopts an objective function of minimizing a sum of an investment cost and a maintenance cost and takes equipment capacity connection constraints and capacity limit constraints as constraint conditions;
generating multiple operating scenarios of a power system by using a k-means clustering algorithm according to the relevant historical data;
constructing a time-series production simulation model of the power system containing hydrogen long-duration energy storage according to a given capacity evolution sequence output by the capacity evolution sequence generation model and the multiple operating scenarios of the power system, wherein the time-series production simulation model of the power system takes carbon emission limit constraints and clean energy power generation share constraints as core constraints and adopts an objective function of minimizing a sum of an operating cost and a carbon trading cost;
constructing a data-model hybrid-driven model capable of measuring system cleanliness and low-carbon performance by using convolutional neural network-bidirectional gated recurrent unit-attention mechanism (CNN-BiGRU-AM), based on the capacity evolution sequence generation model and the time-series production simulation model of the power system containing hydrogen long-duration energy storage, wherein the data-model hybrid-driven model takes the capacity evolution sequence output by the capacity evolution sequence generation model as input and takes a corresponding marginal cost of electricity share and a corresponding marginal cost of carbon allowances as output;
constructing a low-carbon evolution path simulation model of the power system according to the marginal cost of electricity share, the marginal cost of carbon allowances, a minimized sum of the investment cost and the maintenance cost, and a minimized sum of the operating cost and the carbon trading cost, wherein the low-carbon evolution path simulation model of the power system considers hydrogen long-duration energy storage and involves economic cost driving factors, clean energy power generation share driving factors, and carbon emission limit driving factors; and
constructing a two-layer solution framework according to the low-carbon evolution path simulation model of the power system, wherein the two-layer solution framework comprises a capacity layer and an operation layer and has an objective of minimizing a comprehensive benefit cost, the capacity layer adopts a Proportional-Integral-Derivative (PID) search algorithm, and the operation layer adopts an improved differential evolution algorithm to obtain a low-carbon evolution path of the power system considering hydrogen long-duration energy storage.

2. The method for simulating a low-carbon evolution path of a power system according to claim 1, wherein according to the relevant historical data and the future planning data, the investment cost evolution model considering the uncertainty of technological innovation breakthrough rate is constructed based on a two-factor learning curve model.

3. The method for simulating a low-carbon evolution path of a power system according to claim 1, wherein the investment cost evolution model is:
$$\begin{matrix}{α}_{y} = {α}_{0} {A}_{y} {B}_{y} ; \\ {A}_{y} = {( \frac{{N}_{y}}{{N}_{0}} )}^{- a} ; \\ {B}_{y} = {{u}_{y} ( \frac{{C}_{y}}{{C}_{0}} )}^{- b} + ( 1 - {u}_{y} ) {B}_{y - 1} ;\end{matrix}$$
wherein α_{y} is an investment cost per unit capacity in a y-th year; α₀ is an initial investment cost per unit capacity; A_{y} is a reduction level of the investment cost per unit capacity caused by an increase in an installed capacity scale in the y-th year; B_{y} is a reduction level of the investment cost per unit capacity caused by an increase in a research and development investment in the y-th year; N_{y} is a cumulative installed capacity scale in the y-th year; N₀ is an initial installed capacity scale; a is a learning rate index of the cumulative installed capacity scale; u_{y} is a binary variable that is set to 1 after a breakthrough is made in technological innovation and set to 0 if no breakthrough is made in technological innovation; C_{y} is a cumulative research and development investment in the y-th year; C₀ is an initial research and development investment; b is a learning rate index of the cumulative research and development investment; and B_{y-1} is a reduction level of the investment cost per unit capacity caused by an increase in the research and development investment in a (y−1)-th year.

4. The method for simulating a low-carbon evolution path of a power system according to claim 1, wherein the objective function of the capacity evolution sequence generation model is:
$$\begin{matrix}min {F}_{1} = min ( {F}^{i n v} + {F}^{m a i n} ) \\ {F}^{i n v} = {\sum }_{{Ω}^{k n}} {\sum }_{{Ω}^{y}} ( {c}_{kn , y}^{inv , p} {P}_{kn , y} + {c}_{kn , y}^{inv , e} {E}_{kn , y} ) - {F}^{s a} \\ {F}^{s a} = {\sum }_{{Ω}^{k}} {ρ}_{k} ( {c}_{k , Y}^{inv , p} {P}_{k , Y} + {c}_{k , Y}^{inv , e} {E}_{k , Y} ) \frac{{H}_{k , Y}}{{T}_{k}} \\ {H}_{k , Y} = \{ \begin{matrix}\begin{matrix}0 , & {Y}_{0} \leq ( Y - {T}_{k} + 1 )\end{matrix} \\ {T}_{k} - ( Y - {Y}_{0} + 1 ) , {Y}_{0} > ( Y - {T}_{k} + 1 )\end{matrix} \\ {F}^{m a i n} = {\sum }_{{Ω}^{k}} {\sum }_{{Ω}^{y}} ( {c}_{k , y}^{main , p} {P}_{k , y} + {c}_{k , y}^{main , e} {E}_{k , y} )\end{matrix}$$
wherein F₁ is a cost of the capacity evolution sequence generation model; F^{inv} is the investment cost; F^{main} is the maintenance cost; Ω^{kn} is a set of newly added devices; Ω^{y} is a set of planning years;
$${c}_{kn , y}^{inv , p}$$
is investment costs per unit capacity of various types of energy devices; P_{kn,y} is an installed capacity of newly added devices in a y-th year;
$${c}_{kn , y}^{inv , e}$$
is investment costs per unit energy of the various types of energy devices; E_{kn,y} is energy of the newly added devices in the y-th year; F^{sa} is a residual value of non-retired devices within a planning period; Ω^{k} is a set of online energy devices; ρₖ is a residual value recovery coefficient;
$${c}_{k , Y}^{inv , p}$$
is an investment cost per unit capacity in a final year of the planning period; P_{k,Y} is an installed capacity in the final year of the planning period;
$${c}_{k , Y}^{inv , e}$$
is an investment cost per unit energy in the final year of the planning period; E_{k,Y} is energy in the final year of the planning period; H_{k,Y} is remaining lifespans of the various types of energy devices at an end of the planning period; Tₖ is service life of various types of energy devices; Y₀ is a time point when an energy device begins to be used;
$${c}_{k , y}^{main , p}$$
is maintenance costs per unit capacity of the various types of energy devices;
$${c}_{k , y}^{main , e}$$
is maintenance costs per unit energy of the various types of energy devices; and Y is the final year of the planning period.

5. The method for simulating a low-carbon evolution path of a power system according to claim 1, wherein the objective function of the time-series production simulation model of the power system containing hydrogen long-duration energy storage is:
$$min {F}_{2} = min ( {F}^{o m} + {F}^{c o} )$$
$${F}^{o m} = {\sum }_{{Ω}^{k}} {\sum }_{{Ω}^{y}} {\sum }_{{Ω}^{s}} {\sum }_{{Ω}^{t}} ( {c}_{y}^{c o a l} {q}_{k , y , s , t}^{c o a l} + {c}_{y}^{g a s} {q}_{k , y , s , t}^{g a s} + {c}_{y}^{h y} {q}_{k , y , s , t}^{h y} ) Δ t + {C}_{k , y , s , t}^{U} + {C}_{k , y , s , t}^{D}$$
$${F}^{c o} = {\sum }_{{Ω}^{y}} {c}_{y}^{c o} \cdot {CO}_{y}$$
wherein F₂ is a cost of the time-series production simulation model; F^{om} is the operating cost; F^{co} is the carbon trading cost; Ω^{k} is a set of online energy devices; Ω^{y} is a set of planning years; Ω^{S} is a set of operating scenarios; Ω^{t} is a set of daily operating times;
$${c}_{y}^{c o a l}$$
is a cost per unit of coal consumption;
$${q}_{k , y , s , t}^{coal}$$
is coal consumption;
$${c}_{y}^{g a s}$$
is a cost per unit of natural gas consumption;
$${q}_{k , y , s , t}^{gas}$$
is natural gas consumption;
$${c}_{y}^{h y}$$
is a cost per unit of hydrogen consumption;
$${q}_{k , y , s , t}^{hy}$$
is hydrogen consumption; Δt is a time interval;
$${C}_{k , y , s , t}^{U}$$
is a startup cost of thermal power units;
$${C}_{k , y , s , t}^{D}$$
is a shutdown cost;
$${c}_{y}^{co}$$
is a carbon trading price in a y-th year; CO_{y} is a total carbon trading volume in the y-th year.

6. The method for simulating a low-carbon evolution path of a power system according to claim 1, wherein the constructing the data-model hybrid-driven model capable of measuring system cleanliness and low-carbon performance by using the CNN-BiGRU-AM, based on the capacity evolution sequence generation model and the time-series production simulation model of the power system containing hydrogen long-duration energy storage comprises:
applying a random function to generate a random capacity evolution sequence based on the capacity evolution sequence generation model;
inputting the random capacity evolution sequence into the time-series production simulation model of the power system containing hydrogen long-duration energy storage to obtain the minimized sum of the operating cost and the carbon trading cost;
calculating the corresponding marginal cost of electricity share and marginal cost of carbon allowances by adjusting clean energy power generation share or a carbon emission limit, with reference to the minimized sum of the operating cost and the carbon trading cost; and
with the random capacity evolution sequence as input and the corresponding marginal cost of electricity share and the corresponding marginal cost of carbon allowances as output, training the CNN-BiGRU-AM to obtain the data-model hybrid-driven model capable of measuring system cleanliness and low-carbon performance.

7. The method for simulating a low-carbon evolution path of a power system according to claim 1, wherein the low-carbon evolution path simulation model of the power system considering hydrogen long-duration energy storage is:
$$V = {ω}^{F} {V}^{F} + {ω}^{n e w} {V}^{n e w} + {ω}^{c o} {V}^{c o} ;$$
wherein V is a comprehensive benefit cost value; ω^{F} is a weight coefficient under an economic cost driver; V^{F} is a benefit cost value under the economic cost driver; ω^{new} is a weight coefficient under a clean energy power generation share driver; V^{new} is a benefit cost value under the clean energy power generation share driver; ω^{co} is a weight coefficient under a carbon emission limit driver; and V^{co} is a benefit cost value under the carbon emission limit driver.

8. A computer device, comprising: a memory, a processor, and a computer program stored in the memory and executable on the processor, wherein the processor executes the computer program to implement the method for simulating a low-carbon evolution path of a power system according to claim 1.

9. A non-transitory computer-readable storage medium, wherein the computer-readable storage medium stores a computer program, and the computer program, when executed by a processor, implements the method for simulating a low-carbon evolution path of a power system according to claim 1.

10. The computer device according to claim 8, wherein according to the relevant historical data and the future planning data, the investment cost evolution model considering the uncertainty of technological innovation breakthrough rate is constructed based on a two-factor learning curve model.

11. The computer device according to claim 8, wherein the investment cost evolution model is:
$${α}_{y} = {α}_{0} {A}_{y} {B}_{y} ;$$
$${A}_{y} = {( \frac{{N}_{y}}{{N}_{0}} )}^{- a} ;$$
$${B}_{y} = {{u}_{y} ( \frac{{c}_{y}}{{c}_{0}} )}^{- b} + ( 1 - {u}_{y} ) {B}_{y - 1} ;$$
wherein α_{y} is an investment cost per unit capacity in a y-th year; α₀ is an initial investment cost per unit capacity; A_{y} is a reduction level of the investment cost per unit capacity caused by an increase in an installed capacity scale in the y-th year; B_{y} is a reduction level of the investment cost per unit capacity caused by an increase in a research and development investment in the y-th year; N_{y} is a cumulative installed capacity scale in the y-th year; N₀ is an initial installed capacity scale; a is a learning rate index of the cumulative installed capacity scale; u_{y} is a binary variable that is set to 1 after a breakthrough is made in technological innovation and set to 0 if no breakthrough is made in technological innovation; C_{y} is a cumulative research and development investment in the y-th year; C₀ is an initial research and development investment; b is a learning rate index of the cumulative research and development investment; and B_{y-1} is a reduction level of the investment cost per unit capacity caused by an increase in the research and development investment in a (y−1)-th year.

12. The computer device according to claim 8, wherein the objective function of the capacity evolution sequence generation model is:
$$min {F}_{1} = min ( {F}^{i n v} + {F}^{m a i n} )$$
$${F}^{i n v} = {\sum }_{{Ω}^{k n}} {\sum }_{{Ω}^{y}} ( {c}_{kn , y}^{inv , p} {P}_{kn , y} + {c}_{kn , y}^{inv , e} {E}_{kn , y} ) - {F}^{s a}$$
$${F}^{s a} = {\sum }_{{Ω}^{k}} {ρ}_{k} ( {c}_{k , Y}^{inv , p} {P}_{k , Y} + {c}_{k , Y}^{inv , e} {E}_{k , Y} ) \frac{{H}_{k , Y}}{{T}_{k}}$$
$${H}_{k , Y} = \{ \begin{matrix}0 , & {Y}_{0} \leq ( Y - {T}_{k} + 1 ) \\ {T}_{k} - ( Y - {Y}_{0} + 1 ) , & {Y}_{0} > ( Y - {T}_{k} + 1 )\end{matrix}$$
$${F}^{m a i n} = {\sum }_{{Ω}^{k}} {\sum }_{{Ω}^{y}} ( {c}_{k , y}^{main , p} {P}_{k , y} + {c}_{k , y}^{main , e} {E}_{k , y} )$$
wherein F₁ is a cost of the capacity evolution sequence generation model; F^{inv} is the investment cost; F^{main} is the maintenance cost; Ω^{kn} is a set of newly added devices; Ω^{y} is a set of planning years;
$${c}_{kn , y}^{inv , p}$$
is investment costs per unit capacity of various types of energy devices; P_{kn,y} is an installed capacity of newly added devices in a y-th year;
$${c}_{kn , y}^{inv , e}$$
is investment costs per unit energy of the various types of energy devices; E_{kn,y} is energy of the newly added devices in the y-th year; F^{sa} is a residual value of non-retired devices within a planning period; Ω^{k} is a set of online energy devices; ρₖ is a residual value recovery coefficient;
$${c}_{k , Y}^{inv , p}$$
is an investment cost per unit capacity in a final year of the planning period; P_{k,Y} is an installed capacity in the final year of the planning period;
$${c}_{k , Y}^{inv , e}$$
is an investment cost per unit energy in the final year of the planning period; E_{k,Y} is energy in the final year of the planning period; H_{k,Y} is remaining lifespans of the various types of energy devices at an end of the planning period; Tₖ is service life of various types of energy devices; Y₀ is a time point when an energy device begins to be used;
$${c}_{k , y}^{main , p}$$
is maintenance costs per unit capacity of the various types of energy devices;
$${c}_{k , y}^{main , e}$$
is maintenance costs per unit energy of the various types of energy devices; and Y is the final year of the planning period.

13. The computer device according to claim 8, wherein the objective function of the time-series production simulation model of the power system containing hydrogen long-duration energy storage is:
$$min {F}_{2} = min ( {F}^{o m} + {F}^{c o} )$$
$${F}^{o m} = {\sum }_{{Ω}^{k}} {\sum }_{{Ω}^{y}} {\sum }_{{Ω}^{s}} {\sum }_{{Ω}^{t}} ( {c}_{y}^{c o a l} {q}_{k , y , s , t}^{c o a l} + {c}_{y}^{g a s} {q}_{k , y , s , t}^{g a s} + {c}_{y}^{h y} {q}_{k , y , s , t}^{h y} ) Δ t + {C}_{k , y , s , t}^{U} + {C}_{k , y , s , t}^{D}$$
$${F}^{c o} = {\sum }_{Ω y} {c}_{y}^{c o} \cdot {CO}_{y}$$
wherein F₂ is a cost of the time-series production simulation model; F^{om} is the operating cost; F^{co} is the carbon trading cost; Ω^{k} is a set of online energy devices; Ω^{y} is a set of planning years; Ω^{s} is a set of operating scenarios; Ω^{t} is a set of daily operating times;
$${c}_{y}^{c o a l}$$
is a cost per unit of coal consumption;
$${q}_{k , y , s , t}^{c o a l}$$
is coal consumption;
$${c}_{y}^{g a s}$$
is a cost per unit of natural gas consumption;
$${q}_{k , y , s , t}^{gas}$$
is natural gas consumption;
$${c}_{y}^{h y}$$
is a cost per unit of hydrogen consumption;
$${q}_{k , y , s , t}^{hy}$$
is hydrogen consumption; Δt is a time interval;
$${C}_{k , y , s , t}^{U}$$
is a startup cost of thermal power units;
$${C}_{k , y , s , t}^{D}$$
is a shutdown cost;
$${c}_{y}^{c o}$$
is a carbon trading price in a y-th year; CO_{y} is a total carbon trading volume in the y-th year.

14. The computer device according to claim 8, wherein the constructing the data-model hybrid-driven model capable of measuring system cleanliness and low-carbon performance by using the CNN-BiGRU-AM, based on the capacity evolution sequence generation model and the time-series production simulation model of the power system containing hydrogen long-duration energy storage comprises:
applying a random function to generate a random capacity evolution sequence based on the capacity evolution sequence generation model;
inputting the random capacity evolution sequence into the time-series production simulation model of the power system containing hydrogen long-duration energy storage to obtain the minimized sum of the operating cost and the carbon trading cost;
calculating the corresponding marginal cost of electricity share and marginal cost of carbon allowances by adjusting clean energy power generation share or a carbon emission limit, with reference to the minimized sum of the operating cost and the carbon trading cost; and
with the random capacity evolution sequence as input and the corresponding marginal cost of electricity share and the corresponding marginal cost of carbon allowances as output, training the CNN-BiGRU-AM to obtain the data-model hybrid-driven model capable of measuring system cleanliness and low-carbon performance.

15. The computer device according to claim 8, wherein the low-carbon evolution path simulation model of the power system considering hydrogen long-duration energy storage is:
$$V = {ω}^{F} {V}^{F} + {ω}^{n e w} {V}^{n e w} + {ω}^{c o} {V}^{c o} ;$$
wherein V is a comprehensive benefit cost value; ω^{F} is a weight coefficient under an economic cost driver; V^{F} is a benefit cost value under the economic cost driver; ω^{new} is a weight coefficient under a clean energy power generation share driver; V^{new} is a benefit cost value under the clean energy power generation share driver; ω^{co} is a weight coefficient under a carbon emission limit driver; and V^{co} is a benefit cost value under the carbon emission limit driver.

16. The non-transitory computer-readable storage medium according to claim 9, wherein according to the relevant historical data and the future planning data, the investment cost evolution model considering the uncertainty of technological innovation breakthrough rate is constructed based on a two-factor learning curve model.

17. The non-transitory computer-readable storage medium according to claim 9, wherein the investment cost evolution model is:
$${α}_{y} = {α}_{0} {A}_{y} {B}_{y} ;$$
$${A}_{y} = {( \frac{{N}_{y}}{{N}_{0}} )}^{- a} ;$$
$${B}_{y} = {{u}_{y} ( \frac{{c}_{y}}{{c}_{0}} )}^{- b} + ( 1 - {u}_{y} ) {B}_{y - 1} ;$$
wherein α_{y} is an investment cost per unit capacity in a y-th year; α₀ is an initial investment cost per unit capacity; A_{y} is a reduction level of the investment cost per unit capacity caused by an increase in an installed capacity scale in the y-th year; B_{y} is a reduction level of the investment cost per unit capacity caused by an increase in a research and development investment in the y-th year; N_{y} is a cumulative installed capacity scale in the y-th year; N₀ is an initial installed capacity scale; a is a learning rate index of the cumulative installed capacity scale; u_{y} is a binary variable that is set to 1 after a breakthrough is made in technological innovation and set to 0 if no breakthrough is made in technological innovation; C_{y} is a cumulative research and development investment in the y-th year; C₀ is an initial research and development investment; b is a learning rate index of the cumulative research and development investment; and B_{y-1} is a reduction level of the investment cost per unit capacity caused by an increase in the research and development investment in a (y−1)-th year.

18. The non-transitory computer-readable storage medium according to claim 9, wherein the objective function of the capacity evolution sequence generation model is:
$$min {F}_{1} = min ( {F}^{i n v} + {F}^{m a i n} )$$
$${F}^{i n v} = {\sum }_{{Ω}^{k n}} {\sum }_{{Ω}^{y}} ( {c}_{kn , y}^{inv , p} {P}_{kn , y} + {c}_{kn , y}^{inv , e} {E}_{kn , y} ) - {F}^{s a}$$
$${F}^{s a} = {\sum }_{{Ω}^{k}} {ρ}_{k} ( {c}_{k , Y}^{inv , p} {P}_{k , Y} + {c}_{k , Y}^{inv , e} {E}_{k , Y} ) \frac{{H}_{k , Y}}{{T}_{k}}$$
$${H}_{k , Y} = \{ \begin{matrix}0 , & {Y}_{0} \leq ( Y - {T}_{k} + 1 ) \\ {T}_{k} - ( Y - {Y}_{0} + 1 ) , & {Y}_{0} > ( Y - {T}_{k} + 1 )\end{matrix}$$
$${F}^{m a i n} = {\sum }_{{Ω}^{k}} {\sum }_{{Ω}^{y}} ( {c}_{k y}^{main , p} {P}_{k , y} + {c}_{k , y}^{m a i n , e} {E}_{k , y} )$$
wherein F₁ is a cost of the capacity evolution sequence generation model; F^{inv} is the investment cost; F^{main} is the maintenance cost; Ω^{kn} is a set of newly added devices; Ω^{y} is a set of planning years;
$${c}_{kn , y}^{inv , p}$$
is investment costs per unit capacity of various types of energy devices; P_{kn,y} is an installed capacity of newly added devices in a y-th year;
$${c}_{kn , y}^{inv , e}$$
is investment costs per unit energy of the various types of energy devices; E_{kn,y} is energy of the newly added devices in the y-th year; F^{sa} is a residual value of non-retired devices within a planning period; Ω^{k} is a set of online energy devices; ρₖ is a residual value recovery coefficient;
$${c}_{k , Y}^{inv , p}$$
is an investment cost per unit capacity in a final year of the planning period; P_{k,Y} is an installed capacity in the final year of the planning period;
$${c}_{k , Y}^{inv , e}$$
is an investment cost per unit energy in the final year of the planning period; E_{k,Y} is energy in the final year of the planning period; H_{k,Y} is remaining lifespans of the various types of energy devices at an end of the planning period; Tₖ is service life of various types of energy devices; Y₀ is a time point when an energy device begins to be used;
$${c}_{k , y}^{main , p}$$
is maintenance costs per unit capacity of the various types of energy devices;
$${c}_{k , y}^{main , e}$$
is maintenance costs per unit energy of the various types of energy devices; and Y is the final year of the planning period.

19. The non-transitory computer-readable storage medium according to claim 9, wherein the objective function of the time-series production simulation model of the power system containing hydrogen long-duration energy storage is:
$$min {F}_{2} = min ( {F}^{o m} + {F}^{c o} )$$
$${F}^{o m} = {\sum }_{{Ω}^{k}} {\sum }_{{Ω}^{y}} {\sum }_{{Ω}^{s}} {\sum }_{{Ω}^{t}} ( {c}_{y}^{coal} {q}_{k , y , s , t}^{coal} + {c}_{y}^{g a s} {q}_{k , y , s , t}^{g a s} + {c}_{y}^{h y} {q}_{k , y , s , t}^{h y} ) Δ t + {C}_{k , y , s , t}^{U} + {C}_{k , y , s , t}^{D}$$
$${F}^{c o} = {\sum }_{{Ω}^{y}} {c}_{y}^{c o} \cdot {CO}_{y}$$
wherein F₂ is a cost of the time-series production simulation model; F^{om} is the operating cost; F^{co} is the carbon trading cost; Ω^{k} is a set of online energy devices; Ω^{y} is a set of planning years; Ω^{s} is a set of operating scenarios; Ω^{t} is a set of daily operating times;
$${c}_{y}^{c o a l}$$
is a cost per unit of coal consumption;
$${q}_{k , y , s , t}^{c o a l}$$
is coal consumption;
$${c}_{y}^{g a s}$$
is a cost per unit of natural gas consumption;
$${q}_{k , y , s , t}^{gas}$$
is natural gas consumption;
$${c}_{y}^{h y}$$
is a cost per unit of hydrogen consumption;
$${q}_{k , y , s , t}^{hy}$$
is hydrogen consumption; Δt is a time interval;
$${C}_{k , y , s , t}^{U}$$
is a startup cost of thermal power units;
$${C}_{k , y , s , t}^{D}$$
is a shutdown cost;
$${c}_{y}^{c o}$$
is a carbon trading price in a y-th year; CO_{y} is a total carbon trading volume in the y-th year.

20. The non-transitory computer-readable storage medium according to claim 9, wherein the constructing the data-model hybrid-driven model capable of measuring system cleanliness and low-carbon performance by using the CNN-BiGRU-AM, based on the capacity evolution sequence generation model and the time-series production simulation model of the power system containing hydrogen long-duration energy storage comprises:
applying a random function to generate a random capacity evolution sequence based on the capacity evolution sequence generation model;
inputting the random capacity evolution sequence into the time-series production simulation model of the power system containing hydrogen long-duration energy storage to obtain the minimized sum of the operating cost and the carbon trading cost;
calculating the corresponding marginal cost of electricity share and marginal cost of carbon allowances by adjusting clean energy power generation share or a carbon emission limit, with reference to the minimized sum of the operating cost and the carbon trading cost; and
with the random capacity evolution sequence as input and the corresponding marginal cost of electricity share and the corresponding marginal cost of carbon allowances as output, training the CNN-BiGRU-AM to obtain the data-model hybrid-driven model capable of measuring system cleanliness and low-carbon performance.
